(19) United States
(12) Patent Application Publication
(10) Pub. No.: US 2023/0104857 A1
(43) Pub. Date: Apr. 6, 2023

(54) INDICATING MOTION INFORMATION ASSOCIATED WITH A HIGH-ALTITUDE PLATFORM STATION

(71) Applicant: QUALCOMM Incorporated, San Diego, CA (US)

(72) Inventors: Liangping MA, San Diego, CA (US); Xiao Feng WANG, San Diego, CA (US); Bharat SHRESTHA, San Diego, CA (US); Umesh PHUYAL, San Diego, CA (US); Harikumar KRISHNAMURTHY, San Diego, CA (US); Changhwan PARK, San Diego, CA (US); Alberto RICO ALVARINO, San Diego, CA (US); Ayan SENGUPTA, San Diego, CA (US)

(21) Appl. No.: 17/937,770

(22) Filed: Oct. 3, 2022

Related U.S. Application Data
(60) Provisional application No. 63/262,069, filed on Oct. 4, 2021.

(51) Int. Cl. H04W 64/00; H04B 7/185

(52) U.S. Cl. CPC H04W 64/006; H04B 7/18504

(57) ABSTRACT

Various aspects of the present disclosure generally relate to wireless communication. In some aspects, a user equipment (UE) may receive, from a network node, motion information associated with a high-altitude platform station (HAPS). The UE may communicate with at least one of the network node or a different network node based at least in part on the motion information. Numerous other aspects are described.

### CROSS-REFERENCE TO RELATED APPLICATION

This Patent Application claims priority to U.S. Provisional Patent Application No. 63/262,069, filed on Oct. 4, 2021, entitled “INDICATING MOTION INFORMATION ASSOCIATED WITH A HIGH-ALTITUDE PLATFORM STATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for indicating motion information associated with a high-altitude platform station.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include receiving, from a network node, motion information associated with a HAPS. The method may include communicating with at least one of the network node or a different network node based at least in part on the motion information.

Some aspects described herein relate to a method of wireless communication performed by a UE. The method may include receiving, from a network node, motion information associated with a HAPS, wherein the motion information comprises information associated with at least one of a position of the HAPS or a velocity of the HAPS. The method may include communicating with at least one of the network node or a different network node based at least in part on the motion information.

Some aspects described herein relate to a method of wireless communication performed by a UE. The method may include receiving, from a network node, motion information associated with a HAPS, wherein the motion information comprises a trajectory indication that indicates trajectory information associated with the HAPS. The method may include communicating with at least one of the network node or a different network node based at least in part on the motion information.

Some aspects described herein relate to a method of wireless communication performed by a network node. The method may include transmitting motion information associated with a HAPS. The method may include communicating with at least one UE based at least in part on the motion information.

Some aspects described herein relate to a method of wireless communication performed by a network node. The method may include transmitting motion information associated with a HAPS, wherein the motion information comprises information associated with at least one of a position of the HAPS or a velocity of the HAPS. The method may include communicating with at least one UE based at least in part on the motion information.

Some aspects described herein relate to a method of wireless communication performed by a network node. The method may include transmitting motion information associated with a HAPS, wherein the motion information comprises a trajectory indication that indicates trajectory information associated with the HAPS. The method may include communicating with at least one UE based at least in part on the motion information.

Some aspects described herein relate to an apparatus for wireless communication. The apparatus may include a memory comprising instructions and one or more processors configured to execute the instructions. The one or more processors may be configured to execute the instructions and cause the apparatus to obtain, from a network node, motion information associated with a HAPS. The one or more processors may be configured to cause the apparatus to communicate with at least one of the network node or a different network node based at least in part on the motion information.

Some aspects described herein relate to an apparatus for wireless communication. The apparatus may include a memory comprising instructions and one or more processors configured to execute the instructions. The one or more processors may be configured to execute the instructions and cause the apparatus to obtain, from a network node, motion information associated with a HAPS, wherein the motion information comprises information associated with at least one of a position of the HAPS or a velocity of the HAPS. The one or more processors may be configured to cause the apparatus to communicate with at least one of the network node or a different network node based at least in part on the motion information.

Some aspects described herein relate to an apparatus for wireless communication. The apparatus may include a memory comprising instructions and one or more processors configured to execute the instructions. The one or more processors may be configured to execute the instructions and cause the apparatus to obtain, from a network node, motion information associated with a HAPS, wherein the motion information comprises a trajectory indication that indicates trajectory information associated with the HAPS. The one or more processors may be configured to cause the apparatus to communicate with at least one of the network node or a different network node based at least in part on the motion information.

Some aspects described herein relate to an apparatus for wireless communication. The apparatus may include a memory comprising instructions and one or more processors configured to execute the instructions. The one or more processors may be configured to execute the instructions and cause the apparatus to output for transmission motion information associated with a HAPS. The one or more processors may be configured to cause the apparatus to communicate with at least one UE based at least in part on the motion information.

Some aspects described herein relate to an apparatus for wireless communication. The apparatus may include a memory comprising instructions and one or more processors configured to execute the instructions. The one or more processors may be configured to execute the instructions and cause the apparatus to output for transmission motion information associated with a HAPS, wherein the motion information comprises information associated with at least one of a position of the HAPS or a velocity of the HAPS. The one or more processors may be configured to cause the apparatus to communicate with at least one UE based at least in part on the motion information.

Some aspects described herein relate to an apparatus for wireless communication. The apparatus may include a memory comprising instructions and one or more processors configured to execute the instructions. The one or more processors may be configured to execute the instructions and cause the apparatus to output for transmission motion information associated with a HAPS, wherein the motion information comprises a trajectory indication that indicates trajectory information associated with the HAPS. The one or more processors may be configured to cause the apparatus to communicate with at least one UE based at least in part on the motion information.

Some aspects described herein relate to a non-transitory computer-readable medium that stores a set of instructions for wireless communication by a UE. The set of instructions, when executed by one or more processors of the UE, may cause the UE to receive, from a network node, motion information associated with a HAPS. The set of instructions, when executed by one or more processors of the UE, may cause the UE to communicate with at least one of the network node or a different network node based at least in part on the motion information.

Some aspects described herein relate to a non-transitory computer-readable medium that stores a set of instructions for wireless communication by a UE. The set of instructions, when executed by one or more processors of the UE, may cause the UE to receive, from a network node, motion information associated with a HAPS, wherein the motion information comprises information associated with at least one of a position of the HAPS or a velocity of the HAPS. The set of instructions, when executed by one or more processors of the UE, may cause the UE to communicate with at least one of the network node or a different network node based at least in part on the motion information.

Some aspects described herein relate to a non-transitory computer-readable medium that stores a set of instructions for wireless communication by a UE. The set of instructions, when executed by one or more processors of the UE, may cause the UE to receive, from a network node, motion information associated with a HAPS, wherein the motion information comprises a trajectory indication that indicates trajectory information associated with the HAPS. The set of instructions, when executed by one or more processors of the UE, may cause the UE to communicate with at least one of the network node or a different network node based at least in part on the motion information.

Some aspects described herein relate to a non-transitory computer-readable medium that stores a set of instructions for wireless communication by a network node. The set of instructions, when executed by one or more processors of the network node, may cause the network node to transmit motion information associated with a HAPS. The set of instructions, when executed by one or more processors of the network node, may cause the network node to communicate with at least one UE based at least in part on the motion information.

Some aspects described herein relate to a non-transitory computer-readable medium that stores a set of instructions for wireless communication by a network node. The set of instructions, when executed by one or more processors of the network node, may cause the network node to transmit motion information associated with a HAPS, wherein the motion information comprises information associated with at least one of a position of the HAPS or a velocity of the HAPS. The set of instructions, when executed by one or more processors of the network node, may cause the network node to communicate with at least one UE based at least in part on the motion information.

Some aspects described herein relate to a non-transitory computer-readable medium that stores a set of instructions for wireless communication by a network node. The set of instructions, when executed by one or more processors of the network node, may cause the network node to transmit motion information associated with a HAPS, wherein the motion information comprises a trajectory indication that indicates trajectory information associated with the HAPS. The set of instructions, when executed by one or more processors of the network node, may cause the network node to communicate with at least one UE based at least in part on the motion information.

Some aspects described herein relate to an apparatus for wireless communication. The apparatus may include means for receiving, from a network node, motion information associated with a HAPS. The apparatus may include means for communicating with at least one of the network node or a different network node based at least in part on the motion information.

Some aspects described herein relate to an apparatus for wireless communication. The apparatus may include means for receiving, from a network node, motion information associated with a HAPS, wherein the motion information comprises information associated with at least one of a position of the HAPS or a velocity of the HAPS. The apparatus may include means for communicating with at least one of the network node or a different network node based at least in part on the motion information.

Some aspects described herein relate to an apparatus for wireless communication. The apparatus may include means for receiving, from a network node, motion information associated with a HAPS, wherein the motion information comprises a trajectory indication that indicates trajectory information associated with the HAPS. The apparatus may include means for communicating with at least one of the network node or a different network node based at least in part on the motion information.

Some aspects described herein relate to an apparatus for wireless communication. The apparatus may include means for transmitting motion information associated with a HAPS. The apparatus may include means for communicating with at least one UE based at least in part on the motion information.

Some aspects described herein relate to an apparatus for wireless communication. The apparatus may include means for transmitting motion information associated with a HAPS, wherein the motion information comprises information associated with at least one of a position of the HAPS or a velocity of the HAPS. The apparatus may include means for communicating with at least one UE based at least in part on the motion information.

Some aspects described herein relate to an apparatus for wireless communication. The apparatus may include means for transmitting motion information associated with a HAPS, wherein the motion information comprises a trajectory indication that indicates trajectory information associated with the HAPS. The apparatus may include means for communicating with at least one UE based at least in part on the motion information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of a regenerative non-terrestrial deployment and an example of a transparent non-terrestrial deployment in a non-terrestrial network.

FIG. 5 is a diagram illustrating an example associated with indicating motion information associated with a high-altitude platform station (HAPS), in accordance with the present disclosure.

FIGS. 6-11 are diagrams illustrating example processes associated with indicating motion information associated with a HAPS, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

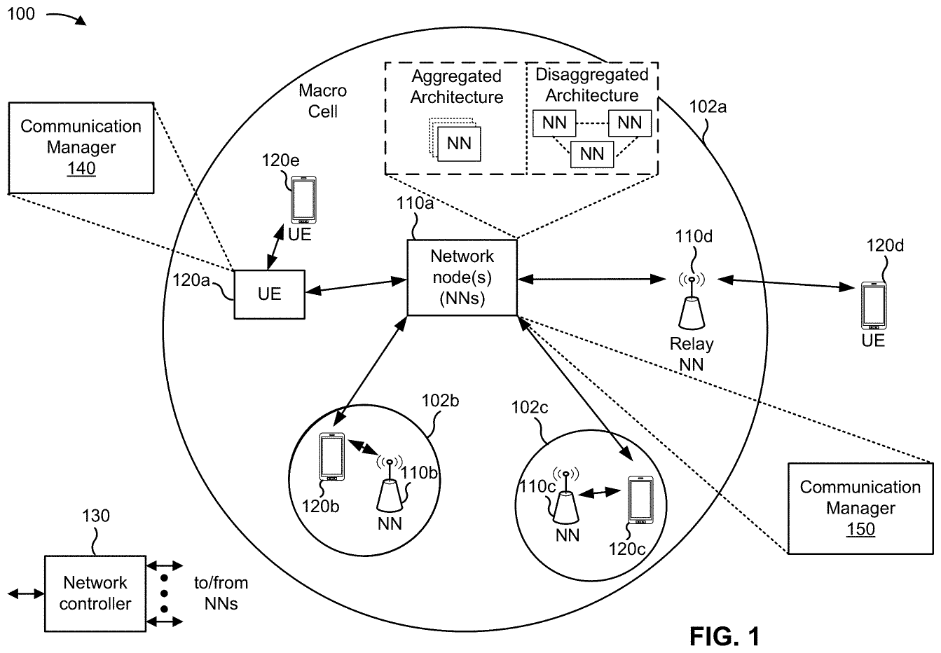

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”) and/or another network node (referred to herein, interchangeably, as a “non-terrestrial network node”). A non-terrestrial network node may include, for example, a base station (referred to herein, interchangeably, as a “non-terrestrial base station”) and/or a relay station (referred to herein, interchangeably, as a “non-terrestrial relay station”), among other examples. As used herein, “NTN” may refer to a network for which access is facilitated by a non-terrestrial UE and/or a non-terrestrial network node.

The wireless network 100 may include any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, helicopter, and/or a dirigible, among other examples. A UAS platform may include a high-altitude platform station (HAPS), and may include a balloon, a dirigible, and/or an airplane, among other examples. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of network nodes (e.g., stationary and/or ground-based network nodes), relay stations, and/or one or more components and/or devices included in a core network of wireless network 100, among other examples.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, motion information associated with a high-altitude platform station (HAPS); and communicate with at least one of the network node or a different network node based at least in part on the motion information. As described in more detail elsewhere herein, the communication manager 140 may receive, from a network node, motion information associated with a HAPS, wherein the motion information comprises information associated with at least one of a position of the HAPS or a velocity of the HAPS; and communicate with at least one of the network node or a different network node based at least in part on the motion information. As described in more detail elsewhere herein, the communication manager 140 may receive, from a network node, motion information associated with a HAPS, wherein the motion information comprises a trajectory indication that indicates trajectory information associated with the HAPS; and communicate with at least one of the network node or a different network node based at least in part on the motion information. Additionally, or alternatively, the communication manager 140 may perform one or more other operations described herein.

In some aspects, the network node may include a communication manager 150. As described in more detail elsewhere herein, the communication manager 150 may transmit motion information associated with a HAPS; and communicate with at least one UE based at least in part on the motion information. As described in more detail elsewhere herein, the communication manager 150 may transmit motion information associated with a HAPS, wherein the motion information comprises information associated with at least one of a position of the HAPS or a velocity of the HAPS; and communicate with at least one UE based at least in part on the motion information. As described in more detail elsewhere herein, the communication manager 150 may transmit motion information associated with a HAPS, wherein the motion information comprises a trajectory indication that indicates trajectory information associated with the HAPS; and communicate with at least one UE based at least in part on the motion information. Additionally, or alternatively, the communication manager 150 may perform one or more other operations described herein.

As indicated above, FIG. 1 is provided as an example. Other examples may differ from what is described with regard to FIG. 1.

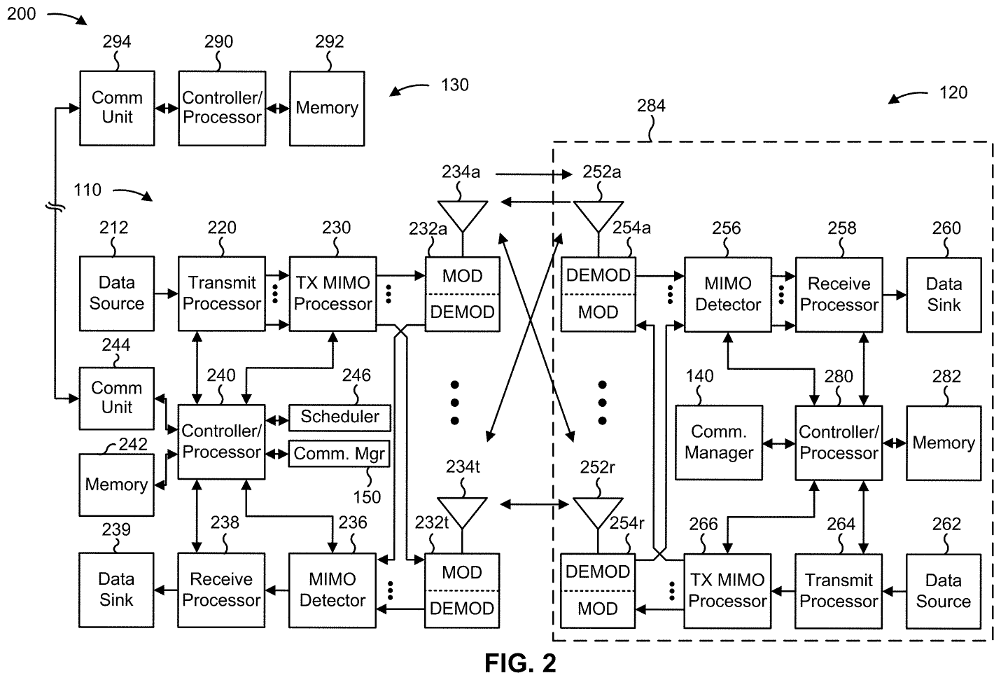

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

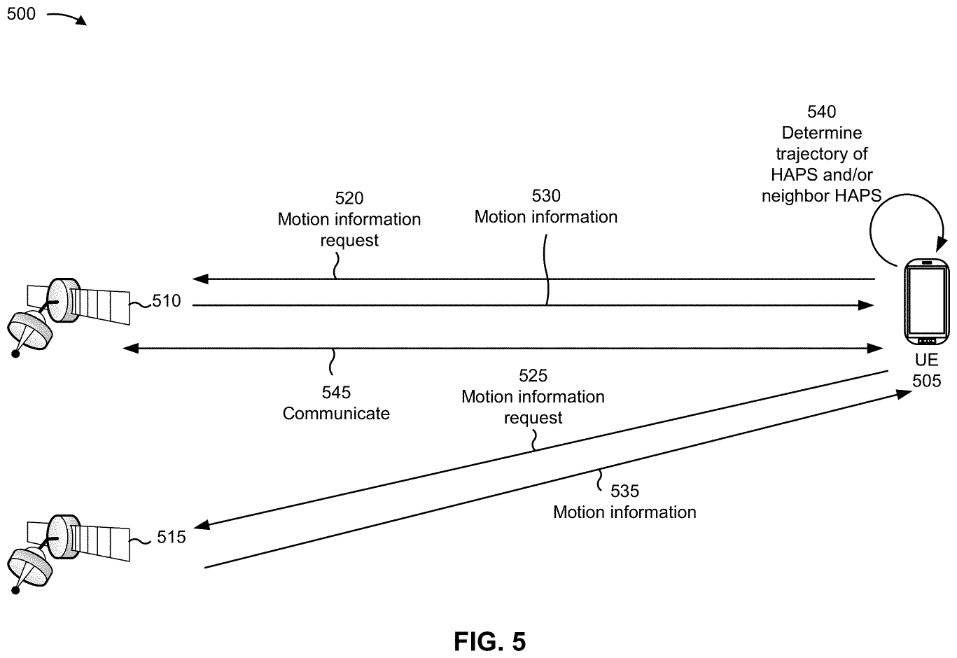

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

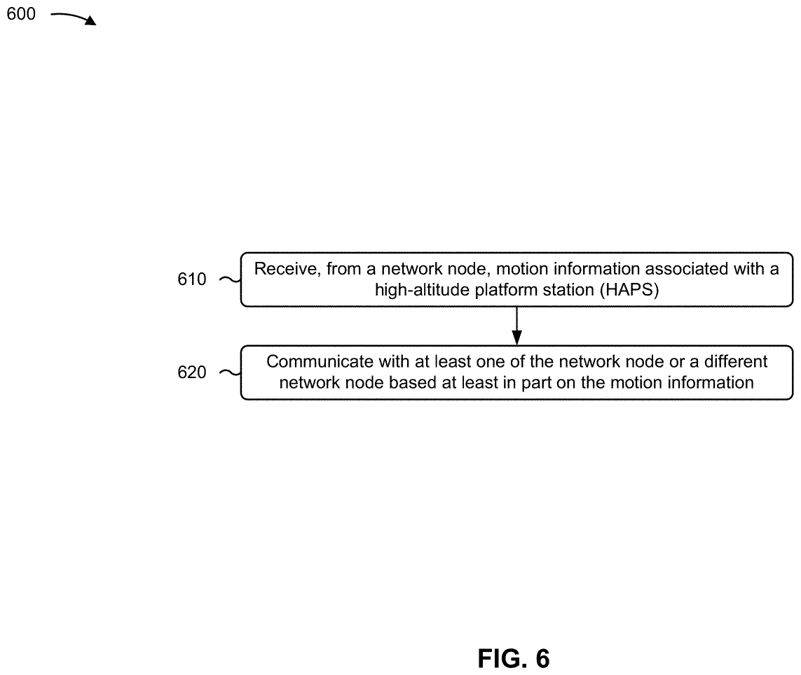

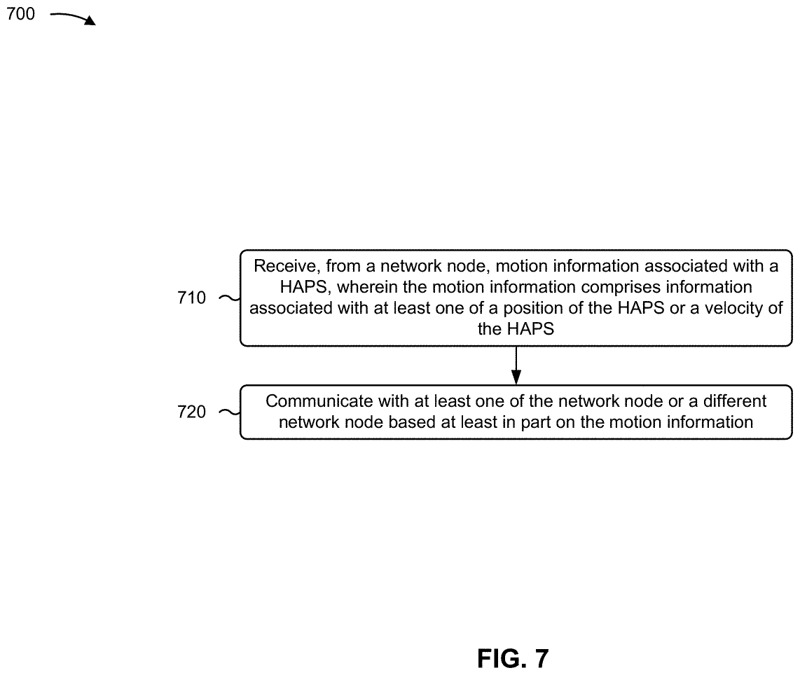

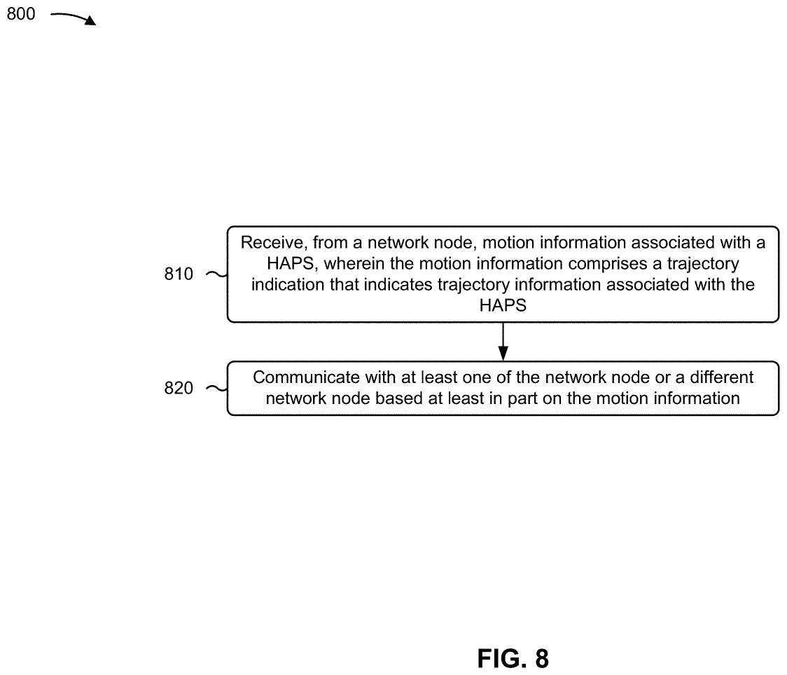

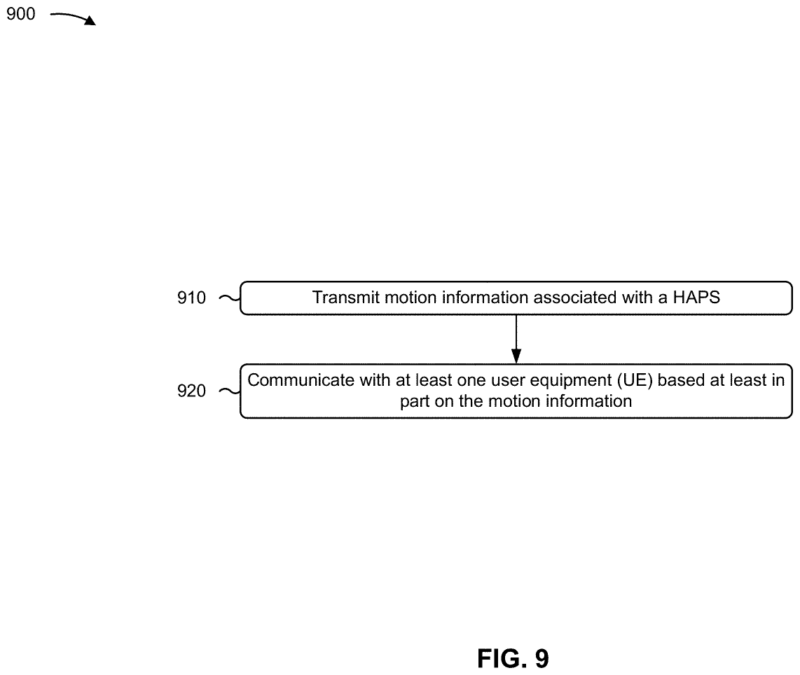

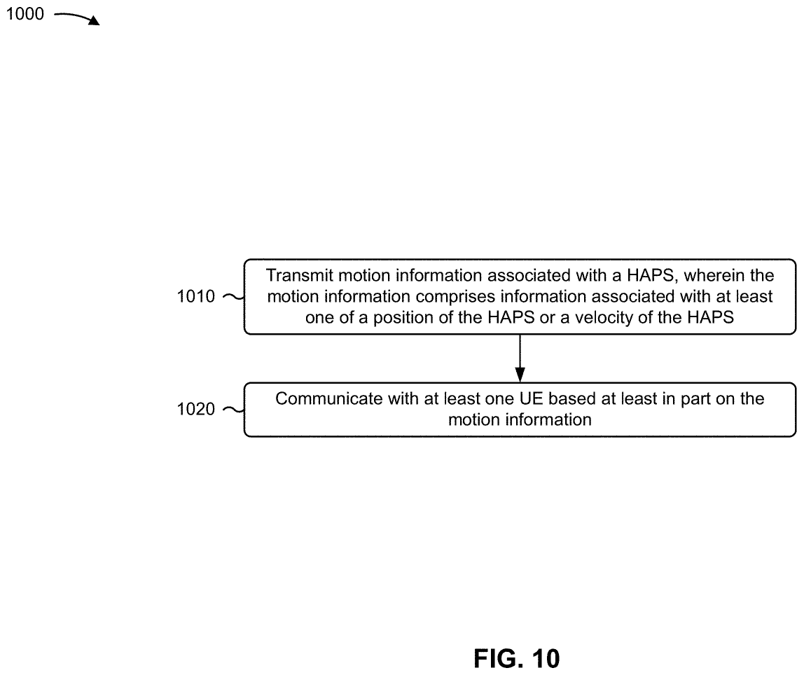

The controller/processor 240 of the network node 110, the controller/processor 280 of the UE 120, and/or any other component(s) of FIG. 2 may perform one or more techniques associated with indicating motion information associated with a HAPS, as described in more detail elsewhere herein. In some aspects, the network node described herein is the base station 110, is included in the base station 110, or includes one or more components of the base station 110 shown in FIG. 2. For example, the controller/processor 240 of the network node 110, the controller/processor 280 of the UE 120, and/or any other component(s) of FIG. 2 may perform or direct operations of, for example, process 500 of FIG. 5, process 600 of FIG. 6, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the base station 110 to perform or direct operations of, for example, process 500 of FIG. 5, process 600 of FIG. 6, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE includes means for receiving, from a network node, motion information associated with a HAPS; and/or means for communicating with at least one of the network node or a different network node based at least in part on the motion information. In some aspects, the UE includes means for receiving, from a network node, motion information associated with a HAPS, wherein the motion information comprises information associated with at least one of a position of the HAPS or a velocity of the HAPS; and/or means for communicating with at least one of the network node or a different network node based at least in part on the motion information. In some aspects, the UE includes means for receiving, from a network node, motion information associated with a HAPS, wherein the motion information comprises a trajectory indication that indicates trajectory information associated with the HAPS; and/or means for communicating with at least one of the network node or a different network node based at least in part on the motion information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting motion information associated with a HAPS; and/or means for communicating with at least one UE based at least in part on the motion information. In some aspects, the network node includes means for transmitting motion information associated with a HAPS, wherein the motion information comprises information associated with at least one of a position of the HAPS or a velocity of the HAPS; and/or means for communicating with at least one UE based at least in part on the motion information. In some aspects, the network node includes means for transmitting motion information associated with a HAPS, wherein the motion information comprises a trajectory indication that indicates trajectory information associated with the HAPS; and/or means for communicating with at least one UE based at least in part on the motion information. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

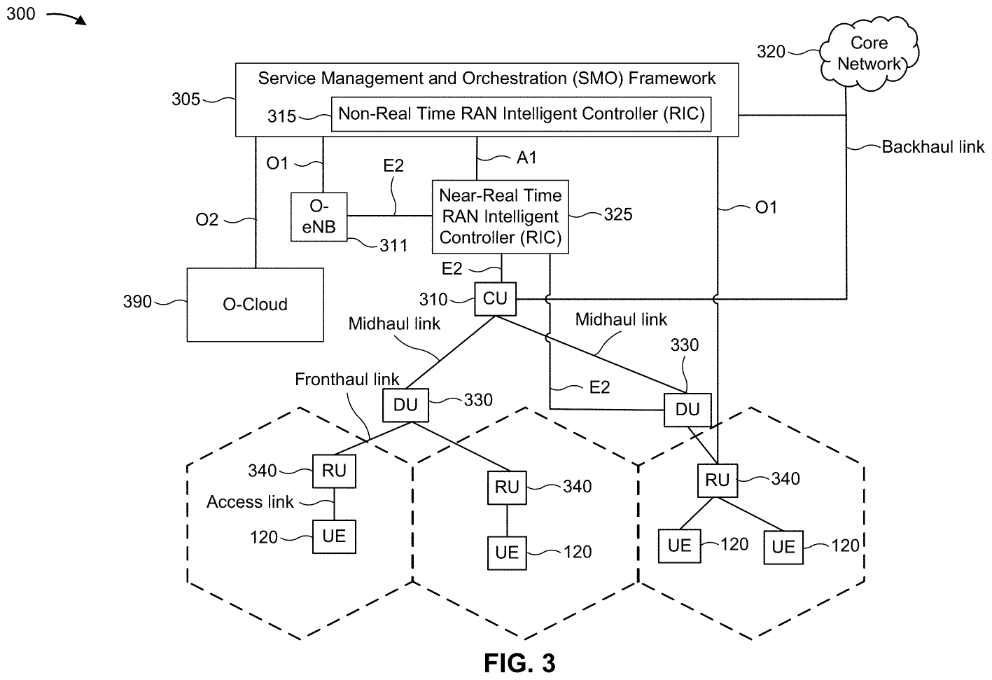

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).4 is a diagram illustrating examples 400 and 410 of NTN deployments. The example 400 and/or the example 410 may be, be similar to, include, or be included in, a wireless network such as the wireless network 100 shown in, and described in connection with, FIG. 1.

Example 400 shows a conceptual depiction of a regenerative satellite deployment. In example 400, a UE 120 is served by a non-terrestrial network node 420 via a service link 430. For example, the non-terrestrial network node 420 may include a network node 110 (e.g., NN 110a) such as a base station, a gNB, or more functions (e.g., RF filtering, frequency conversion, amplification, demodulation, decoding, switching, routing, coding, and/or modulation, among other examples) of a network node 110 and/or a disaggregated base station architecture 300, among other examples. Although illustrated as a satellite, the non-terrestrial network node 420 may be implemented as any type of non-terrestrial device, as described above in connection with FIG. 1.

The service link 430 may include an NR-Uu interface that is terminated at the non-terrestrial network node 420. In some aspects, the non-terrestrial network node 420 may be referred to as a non-terrestrial base station, a regenerative repeater, and/or an on-board processing repeater, among other examples. In some aspects, the non-terrestrial network node 420 may demodulate an uplink radio frequency signal, and may modulate a baseband signal derived from the uplink radio signal to produce a downlink radio frequency transmission. The non-terrestrial network node 420 may transmit the downlink radio frequency signal on the service link 430. The non-terrestrial network node 420 may provide a cell that covers the UE 120.

Example 410 shows a transparent satellite deployment, which may also be referred to as a bent-pipe satellite deployment. In example 410, a UE 120 is served by a non-terrestrial network node 440 (e.g., a satellite) via the service link 430. The non-terrestrial network node 440 may be referred to as a transparent satellite, a bent-pipe satellite, and/or a non-terrestrial relay station, among other examples. The non-terrestrial network node 440 may relay a signal received from a terrestrial network node 110, via an NTN gateway 450. The non-terrestrial network node 440 may repeat an NR-Uu interface via a feeder link 460. The NTN gateway 450 may communicatively connect the non-terrestrial network node 440 and the network node 110 using an RF link 470. For example, the non-terrestrial network node 440 may receive an uplink radio frequency transmission, and may transmit a downlink radio frequency transmission without demodulating the uplink radio frequency transmission. In some aspects, the non-terrestrial network node 440 may frequency convert the uplink radio frequency transmission received on the service link 430 to a frequency of the downlink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability, and/or a Global Positioning System (GPS) capability, among other examples, though not all UEs have such capabilities. The non-terrestrial network node 440 may provide and/or facilitate a cell that covers the UE 120.

The service link 430 may include a link between the non-terrestrial network node 440 and the UE 120, and may include one or more of an uplink or a downlink. The feeder link 460 may include a link between the non-terrestrial network node 440 and the gateway 450, and may include one or more parts of an uplink (e.g., from the UE 120 to the gateway 450) or a downlink (e.g., from the gateway 450 to the UE 120).

The feeder link 460 and the service link 430 may each experience Doppler effects due to the movement of the non-terrestrial network node 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the non-terrestrial network node 420/440 may be associated with an on-board frequency error. These sources of frequency error may cause a received downlink frequency at the UE 120 to drift from a target downlink frequency.

To mitigate the Doppler effect and/or frequency errors and/or to facilitate synchronization, access procedures, and/or other communications, the non-terrestrial network node 420 and/or 440 may provide ephemeris information to the UE 120. The UE 120 may use the ephemeris information, for example, to adjust communication parameters based on a location and/or trajectory of the non-terrestrial device. In some cases, the ephemeris information can include a large number of different types of information such as, for example, satellite position and velocity state vectors and parameters. The position vector may include coordinates x, y, and z associated with an Earth-centered, Earth-fixed (ECEF) coordinate system. The velocity vector may include coordinates Vₓ, V_{y}, and V_{z} associated with the ECEF coordinate system. The parameters may be provided in orbital parameter ephemeris format and may indicate, for example, a semi-major axis, an eccentricity, an argument of periapsis, a longitude of ascending node, an inclination, and/or a mean anomaly at an epoch time, among other examples.

The ephemeris format described above may not be suitable for HAPS implementations. A HAPS, as defined by ITU Radio Regulations, Section IV. Radio Stations and Systems—Article 1.66, is “a station on an object at an altitude of 20 to 50 km and at a specified, nominal, fixed point relative to the Earth.” Accordingly, for example, a HAPS moves at a speed much slower than that of a satellite. Additionally, the maximum service link distance can be too large for physical random access channel (PRACH) formats to support. Additionally, maintaining stationkeeping of a HAPS can be difficult in windy conditions, e.g., when the HAPS is deployed at an altitude lower than 20 km. For position, velocity, time (PVT) systems, the ranges of position, and of velocity for a HAPS are much smaller than those of a satellite. The notion of Keplerian orbital parameters also does not apply to HAPS. Accordingly, using a satellite ephemeris format for HAPS implementations may lead to inaccuracies and inefficiencies in estimating position and movement of a HAPS, thereby having a negative impact on network performance.

Some aspects of techniques and apparatuses described herein may facilitate providing motion information associated with a HAPS to a UE that the UE may use to facilitate communications. In some aspects, a HAPS may transmit, and a UE may receive, motion information associated with the HAPS. The UE may communicate with the HAPS based at least in part on the motion information. Motion information may include position information, velocity information, and/or trajectory information, among other examples associated with a position and/or movement of a HAPS. In this way, some aspects of the subject matter disclosed herein may facilitate providing appropriate motion information associated with a HAPS to a UE for facilitating communications with the UE. As a result, some aspects described herein may lead to improved accuracies and efficiencies in estimating position and movement of a HAPS, thereby having a positive impact on network performance.

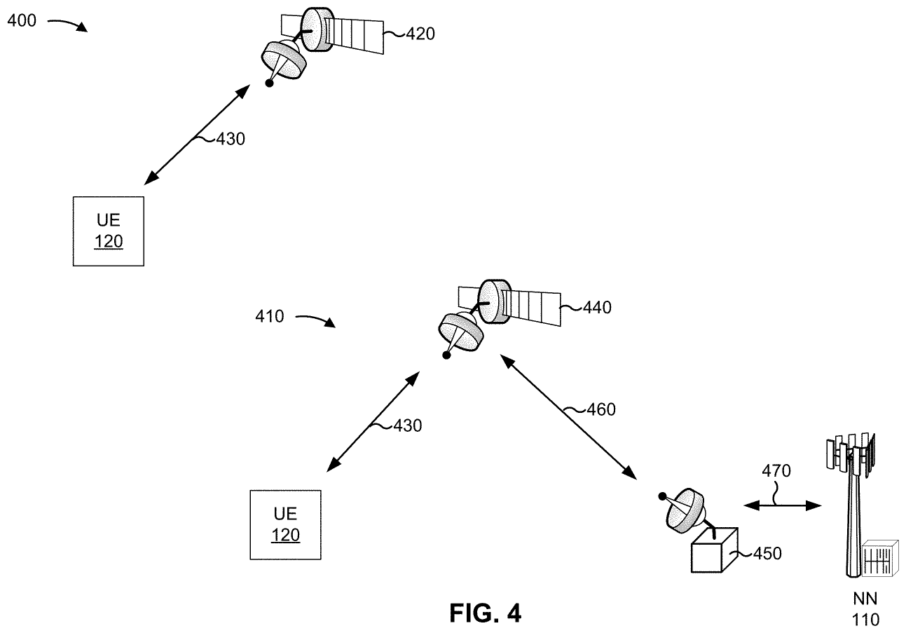

As indicated above, FIG. 4 is provided as an example. Other examples may differ from what is described with regard to FIG. 4.

FIG. 5 is a diagram illustrating an example 500 of indicating motion information associated with a HAPS, in accordance with the present disclosure. As shown in FIG. 5, a UE 505 and a network node 510 may communicate with one another. As is also shown, a neighbor network node 515 may communicate with the UE 505. In some aspects, any number of additional UEs and/or neighbor network nodes may communicate with one another. In some aspects, the network node 510 and/or the network node 515 may include a HAPS, a base station, and/or a gateway, among other examples.

As shown by reference number 520, the UE 505 may transmit, and the network node 510 may receive, a motion information request. In some aspects, the UE 505 may transmit the motion information request while operating in a radio resource control (RRC) idle mode, an RRC inactive mode, or an RRC connected mode. In some aspects, while the UE is operating in an RRC connected mode, the motion information request may include a trajectory indication request. In some aspects, the motion information request may include a neighbor trajectory indication request. The neighbor trajectory indication request may be transmitted to the network node 510. As shown by reference number 525, the UE 505 may transmit, and the neighbor network node 515 may receive, a motion information request (e.g., a neighbor network node trajectory indication request).

As shown by reference number 530, the network node 510 may transmit, and the UE 505 may receive, motion information associated with the network node 510. In some aspects, the network node 510 may transmit, and therefore the UE 505 may receive, the motion information in response to a motion information request. As shown by reference number 535, the neighbor network node 515 may transmit, and the UE 505 may receive, motion information associated with the neighbor network node 515. In some aspects, the network node 510 and/or the neighbor network node 515 may transmit the motion information using a broadcast transmission of a system information block (SIB) that includes the motion information, an RRC message that includes the motion information, a medium access control control element (MAC CE) that includes the motion information, and/or a downlink control information (DCI) transmission that includes the motion information, among other examples.

In some aspects, the motion information may include information associated with at least one of a position of the network node 510 or a velocity of the network node 510. In some aspects, the motion information may indicate a delay pre-compensation to be applied by the UE 505 to uplink transmissions to the network node 510. For example, the delay pre-compensation may include at least one of a number of slots, a number of symbols, a period value Tc (e.g., 1/(480000×4096) seconds), or a multiple of the period value Tc.

In some aspects, the motion information may indicate a position of the network node 510. The motion information may include a current position indication that indicates a current position of the network node 510. In some aspects, the current position indication may indicate a GNSS location of the network node 510, a location of the network node 510 with respect to a local coordinate system (e.g., the North, East, down (NED) system, and/or the East, North, up (ENU) system), and/or a location of the network node 510 with respect to an Earth-centered, Earth-fixed (ECEF) coordinate system. In some aspects, the motion information may indicate an altitude of the network node 510.

In some aspects, the motion information may include a target position indication that indicates a target position of the network node 510 and a deviation indication that indicates a deviation of the network node 510 from the target position. In some aspects, the target position may include a prior position, a current position, a position identified as an average position, and/or an otherwise specified position, among other examples. In some aspects, the target position indication may indicate a GNSS target location of the network node 510, a target location of the network node 510 with respect to a local coordinate system, and/or a target location of the network node 510 with respect to an ECEF coordinate system, among other examples.

In some aspects, the deviation may be broadcast at a higher frequency (e.g., more often) than the target position, and may be in a SIB different from the SIB for the target position. For example, the network node 510 may transmit, and the UE 505 may receive, a first communication that includes the target position indication and a second communication that includes the deviation indication. The first communication may include a first SIB and the second communication may include a second SIB that is different than the first SIB. In some aspects, the network node 510 may transmit, and the UE 505 may receive, at least one instance of a first communication that includes the target position indication and a plurality of instances of a second communication that include the deviation indication. For example, the network node 510 may transmit, and the UE 505 may receive, a plurality of instances of the first communication based at least in part on a first repetition frequency and the plurality of instances of the second communication based at least in part on a second repetition frequency that is higher than the first repetition frequency.

In some aspects, the motion information may be associated with a time instant. The motion information may include a time instant indication that indicates the time instant. In some aspects, the time instant indication may indicate the time instant in accordance with a coordinated universal time. In some aspects, the time instant indication may include an implicit indication. For example, in some aspects, the time instant indication may include a start of a downlink frame in which the motion information is transmitted. In some aspects, the time instant indication may include the frame boundary of a frame immediately after the motion information is transmitted. In some aspects, the motion information also may include a velocity indication that indicates a velocity of the network node 510.

In some aspects, the network node 510 and/or the neighbor network node 515 may transmit, and the UE 505 may receive, motion information associated with at least one additional network node (e.g., the neighbor network node 515). The indication may be carried in a SIB and/or in a response (e.g., RRC, MAC CE) to a request from the UE 505. In some aspects, the motion information associated with the at least one additional network node may include a position indication that indicates a position of the at least one additional network node, a velocity indication that indicates a velocity of the at least one additional network node, and/or an identifier associated with the at least one additional network node, among other examples. For example, in some aspects, the identifier may include a cell identifier associated with the at least one additional network node. The cell identifier may include a physical cell identifier (PCI).

In some aspects, the network node 510 may follow a trajectory, and the network node 510 can indicate the trajectory to the UE 505. Trajectory indications may support long-term predictions of the position of the network node 510. Additionally, using trajectory information, the UE 505 may save frequent SIB readings for network node location related information so that the information may be reused, thereby reducing signaling overhead.

In some aspects, the motion information may include a trajectory indication that indicates trajectory information associated with the network node 510. The trajectory indication may indicate a sequence of position indications. Each position indication may indicate a position of the network node 510 at a corresponding time instant. In some aspects, each position indication may indicate a GNSS location of the network node, a location of the network node with respect to a local coordinate system, and/or a location of the network node with respect to an ECEF coordinate system, among other examples.

In some aspects, each position indication may include a time instant indication that indicates a corresponding time instant. In some aspects, the time instant indication may indicate the corresponding time instant in accordance with a coordinated universal time (UTC). In some aspects, the time instant indication may indicate the corresponding time instant in accordance with a GNSS time. In some aspects, the time instant indication may indicate the corresponding time instant in accordance with a local time. In some aspects, each position indication may include an implicit indication that indicates the corresponding time instant. For example, the implicit indication may include an indication of a downlink frame boundary (e.g., every 1000 frames after the downlink frame in which the trajectory information is transmitted).

In some aspects, the UE 505 may receive, from the network node 510 and/or the neighbor network node 515, a neighbor trajectory indication that indicates trajectory information associated with at least one additional network node. The neighbor trajectory indication may indicate a sequence of neighbor position indications. Each neighbor position indication may indicate a position of the at least one additional network node at a corresponding time instant. Each neighbor position indication may indicate a GNSS location of the at least one additional network node, a location of the at least one additional network node with respect to a local coordinate system, and/or a location of the at least one additional network node with respect to an ECEF coordinate system, among other examples. In some aspects, each position indication may include a time instant indication that indicates the corresponding time instant. The time instant indication may indicate the corresponding time instant in accordance with a UTC. Each neighbor position indication may include an implicit indication that indicates the corresponding time instant. For example, the implicit indication may include an indication of a downlink frame boundary.

As shown by reference number 540, the UE 505 may determine at least one trajectory associated with the network node 510 based at least in part on the trajectory indication. For example, in some aspects, the UE 505 may determine the at least one trajectory by performing an interpolation operation associated with the trajectory indication. In some aspects, the UE 505 may determine at least one trajectory associated with the at least one additional network node based at least in part on the neighbor trajectory indication. In some aspects, the UE 505 may determine the at least one trajectory by performing an interpolation operation associated with the neighbor trajectory indication.

As shown by reference number 545, the UE 505 may communicate with the network node 510 based at least in part on the motion information.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with indicating motion information associated with a HAPS.

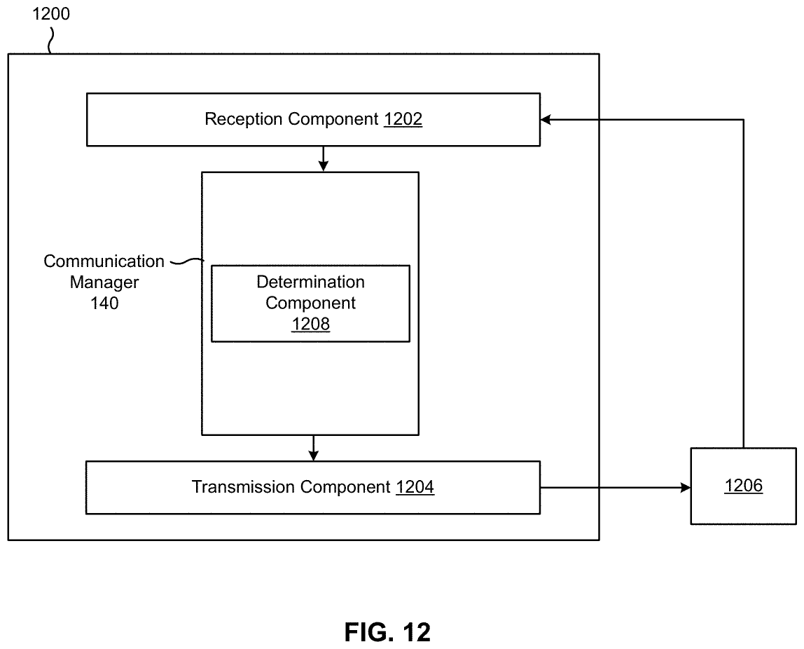

As shown in FIG. 6, in some aspects, process 600 may include receiving, from a network node, motion information associated with a high-altitude platform station (HAPS) (block 610). For example, the UE (e.g., using communication manager 140 and/or reception component 1202, depicted in FIG. 12) may receive, from a network node, motion information associated with a high-altitude platform station (HAPS), as described above.

As further shown in FIG. 6, in some aspects, process 600 may include communicating with at least one of the network node or a different network node based at least in part on the motion information (block 620). For example, the UE (e.g., using communication manager 140, reception component 1202, and/or transmission component 1204, depicted in FIG. 12) may communicate with at least one of the network node or a different network node based at least in part on the motion information, as described above.

Process 600 may include additional aspects, such as any single aspect or any combination of aspects described below and/or in connection with one or more other processes described elsewhere herein.

In a first aspect, the motion information comprises information associated with at least one of a position of the HAPS or a velocity of the HAPS.

In a second aspect, alone or in combination with the first aspect, receiving the motion information comprises receiving a broadcast transmission of a system information block that includes the motion information.

In a third aspect, alone or in combination with one or more of the first and second aspects, receiving the motion information comprises receiving a radio resource control message that includes the motion information.

In a fourth aspect, alone or in combination with one or more of the first through third aspects, receiving the motion information comprises receiving a medium access control control element that includes the motion information.

In a fifth aspect, alone or in combination with one or more of the first through fourth aspects, receiving the motion information comprises receiving a downlink control information transmission that includes the motion information.

In a sixth aspect, alone or in combination with one or more of the first through fifth aspects, the motion information indicates a delay pre-compensation to be applied by the UE to uplink transmissions to the HAPS.

In a seventh aspect, alone or in combination with one or more of the first through sixth aspects, the delay pre-compensation comprises at least one of a number of slots, a number of symbols, a period value, or a multiple of the period value.

In an eighth aspect, alone or in combination with one or more of the first through seventh aspects, the motion information indicates a position of the HAPS.

In a ninth aspect, alone or in combination with one or more of the first through eighth aspects, the motion information comprises a current position indication that indicates a current position of the HAPS.

In a tenth aspect, alone or in combination with one or more of the first through ninth aspects, the current position indication indicates at least one of a global navigation satellite system location of the HAPS, a location of the HAPS with respect to a local coordinate system, or a location of the HAPS with respect to an Earth-centered, Earth-fixed coordinate system.

In an eleventh aspect, alone or in combination with one or more of the first through tenth aspects, the motion information indicates an altitude of the HAPS.

In a twelfth aspect, alone or in combination with one or more of the first through eleventh aspects, the motion information comprises a target position indication that indicates a target position of the HAPS and a deviation indication that indicates a deviation of the HAPS from the target position.

In a thirteenth aspect, alone or in combination with one or more of the first through twelfth aspects, the target position indication indicates at least one of a global navigation satellite system target location of the HAPS, a target location of the HAPS with respect to a local coordinate system, or a target location of the HAPS with respect to an Earth-centered, Earth-fixed coordinate system.

In a fourteenth aspect, alone or in combination with one or more of the first through thirteenth aspects, receiving the motion information comprises receiving a first communication that includes the target position indication, and receiving a second communication that includes the deviation indication.

In a fifteenth aspect, alone or in combination with one or more of the first through fourteenth aspects, the first communication comprises a first system information block (SIB) and the second communication comprises a second SIB that is different than the first SIB.

In a sixteenth aspect, alone or in combination with one or more of the first through fifteenth aspects, receiving the motion information comprises receiving at least one instance of a first communication that includes the target position indication, and receiving a plurality of instances of a second communication that include the deviation indication.

In a seventeenth aspect, alone or in combination with one or more of the first through sixteenth aspects, receiving the at least one instance of the first communication comprises receiving a plurality of instances of the first communication based at least in part on a first repetition frequency, and receiving the plurality of instances of the second communication comprises receiving the plurality of instances of the second communication based at least in part on a second repetition frequency that is higher than the first repetition frequency.

In an eighteenth aspect, alone or in combination with one or more of the first through seventeenth aspects, the motion information is associated with a time instant.

In a nineteenth aspect, alone or in combination with one or more of the first through eighteenth aspects, the motion information includes a time instant indication that indicates the time instant.

In a twentieth aspect, alone or in combination with one or more of the first through nineteenth aspects, the time instant indication indicates the time instant in accordance with a coordinated universal time.

In a twenty-first aspect, alone or in combination with one or more of the first through twentieth aspects, the time instant indication comprises an implicit indication.

In a twenty-second aspect, alone or in combination with one or more of the first through twenty-first aspects, the time instant indication comprises a start of a downlink frame in which the motion information is transmitted.

In a twenty-third aspect, alone or in combination with one or more of the first through twenty-second aspects, the motion information comprises a velocity indication that indicates a velocity of the HAPS.

In a twenty-fourth aspect, alone or in combination with one or more of the first through twenty-third aspects, process 600 includes receiving motion information associated with at least one additional HAPS.

In a twenty-fifth aspect, alone or in combination with one or more of the first through twenty-fourth aspects, the motion information associated with at least one additional HAPS comprises at least one of a position indication that indicates a position of the at least one additional HAPS, a velocity indication that indicates a velocity of the at least one additional HAPS, or an identifier associated with the at least one additional HAPS.

In a twenty-sixth aspect, alone or in combination with one or more of the first through twenty-fifth aspects, the identifier comprises a cell identifier associated with the at least one additional HAPS.

In a twenty-seventh aspect, alone or in combination with one or more of the first through twenty-sixth aspects, the cell identifier comprises a physical cell identifier.

In a twenty-eighth aspect, alone or in combination with one or more of the first through twenty-seventh aspects, receiving the motion information associated with the at least one additional HAPS comprises receiving a system information block that includes the motion information associated with the at least one additional HAPS.

In a twenty-ninth aspect, alone or in combination with one or more of the first through twenty-eighth aspects, process 600 includes transmitting a motion information request to the network node, wherein receiving the motion information associated with at least one additional HAPS comprises receiving a response message corresponding to the request.

In a thirtieth aspect, alone or in combination with one or more of the first through twenty-ninth aspects, the response message comprises at least one of a radio resource control message or a medium access control control element.

In a thirty-first aspect, alone or in combination with one or more of the first through thirtieth aspects, the motion information comprises a trajectory indication that indicates trajectory information associated with the HAPS.

In a thirty-second aspect, alone or in combination with one or more of the first through thirty-first aspects, the trajectory indication indicates a sequence of position indications, wherein each position indication indicates a position of the HAPS at a corresponding time instant.

In a thirty-third aspect, alone or in combination with one or more of the first through thirty-second aspects, each position indication indicates at least one of a global navigation satellite system location of the HAPS, a location of the HAPS with respect to a local coordinate system, or a location of the HAPS with respect to an Earth-centered, Earth-fixed coordinate system.

In a thirty-fourth aspect, alone or in combination with one or more of the first through thirty-third aspects, each position indication comprises a time instant indication that indicates the corresponding time instant.

In a thirty-fifth aspect, alone or in combination with one or more of the first through thirty-fourth aspects, the time instant indication indicates the corresponding time instant in accordance with a coordinated universal time.

In a thirty-sixth aspect, alone or in combination with one or more of the first through thirty-fifth aspects, each position indication comprises an implicit indication that indicates the corresponding time instant.

In a thirty-seventh aspect, alone or in combination with one or more of the first through thirty-sixth aspects, the implicit indication comprises an indication of a downlink frame boundary.

In a thirty-eighth aspect, alone or in combination with one or more of the first through thirty-seventh aspects, process 600 includes transmitting, while operating in a radio resource control connected mode, a trajectory indication request, wherein receiving the motion information comprises receiving the motion information based at least in part on the trajectory indication request.

In a thirty-ninth aspect, alone or in combination with one or more of the first through thirty-eighth aspects, process 600 includes determining at least one trajectory associated with the HAPS based at least in part on the trajectory indication.

In a fortieth aspect, alone or in combination with one or more of the first through thirty-ninth aspects, determining the at least one trajectory comprises performing an interpolation operation associated with the trajectory indication.

In a forty-first aspect, alone or in combination with one or more of the first through fortieth aspects, process 600 includes receiving a neighbor trajectory indication that indicates trajectory information associated with at least one additional HAPS.

In a forty-second aspect, alone or in combination with one or more of the first through forty-first aspects, the neighbor trajectory indication indicates a sequence of neighbor position indications, wherein each neighbor position indication indicates a position of the at least one additional HAPS at a corresponding time instant.

In a forty-third aspect, alone or in combination with one or more of the first through forty-second aspects, each neighbor position indication indicates at least one of a global navigation satellite system location of the at least one additional HAPS, a location of the at least one additional HAPS with respect to a local coordinate system, or a location of the at least one additional HAPS with respect to an Earth-centered, Earth-fixed coordinate system.

In a forty-fourth aspect, alone or in combination with one or more of the first through forty-third aspects, each position indication comprises a time instant indication that indicates the corresponding time instant.

In a forty-fifth aspect, alone or in combination with one or more of the first through forty-fourth aspects, the time instant indication indicates the corresponding time instant in accordance with a coordinated universal time.

In a forty-sixth aspect, alone or in combination with one or more of the first through forty-fifth aspects, each neighbor position indication comprises an implicit indication that indicates the corresponding time instant.

In a forty-seventh aspect, alone or in combination with one or more of the first through forty-sixth aspects, the implicit indication comprises an indication of a downlink frame boundary.

In a forty-eighth aspect, alone or in combination with one or more of the first through forty-seventh aspects, process 600 includes transmitting, while operating in a radio resource control connected mode, a neighbor trajectory indication request, wherein receiving the neighbor trajectory indication comprises receiving the neighbor trajectory indication based at least in part on the neighbor trajectory indication request.

In a forty-ninth aspect, alone or in combination with one or more of the first through forty-eighth aspects, process 600 includes determining at least one trajectory associated with the at least one additional HAPS based at least in part on the neighbor trajectory indication.

In a fiftieth aspect, alone or in combination with one or more of the first through forty-ninth aspects, determining the at least one trajectory comprises performing an interpolation operation associated with the neighbor trajectory indication.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with indicating motion information associated with a HAPS.

As shown in FIG. 7, in some aspects, process 700 may include receiving, from a network node, motion information associated with a HAPS, wherein the motion information comprises information associated with at least one of a position of the HAPS or a velocity of the HAPS (block 710). For example, the UE (e.g., using communication manager 140 and/or reception component 1202, depicted in FIG. 12) may receive, from a network node, motion information associated with a HAPS, wherein the motion information comprises information associated with at least one of a position of the HAPS or a velocity of the HAPS, as described above.

As further shown in FIG. 7, in some aspects, process 700 may include communicating with at least one of the network node or a different network node based at least in part on the motion information (block 720). For example, the UE (e.g., using communication manager 140, reception component 1202, and/or transmission component 1204, depicted in FIG. 12) may communicate with at least one of the network node or a different network node based at least in part on the motion information, as described above.

Process 700 may include additional aspects, such as any single aspect or any combination of aspects described below and/or in connection with one or more other processes described elsewhere herein.

In a first aspect, receiving the motion information comprises receiving a broadcast transmission of a system information block that includes the motion information.

In a second aspect, alone or in combination with the first aspect, receiving the motion information comprises receiving a radio resource control message that includes the motion information.

In a third aspect, alone or in combination with one or more of the first and second aspects, receiving the motion information comprises receiving a medium access control control element that includes the motion information.

In a fourth aspect, alone or in combination with one or more of the first through third aspects, receiving the motion information comprises receiving a downlink control information transmission that includes the motion information.

In a fifth aspect, alone or in combination with one or more of the first through fourth aspects, the motion information indicates a delay pre-compensation to be applied by the UE to uplink transmissions to the HAPS.

In a sixth aspect, alone or in combination with one or more of the first through fifth aspects, the delay pre-compensation comprises at least one of a number of slots, a number of symbols, a period value, or a multiple of the period value.

In a seventh aspect, alone or in combination with one or more of the first through sixth aspects, the motion information indicates a position of the HAPS.

In an eighth aspect, alone or in combination with one or more of the first through seventh aspects, the motion information comprises a current position indication that indicates a current position of the HAPS.

In a ninth aspect, alone or in combination with one or more of the first through eighth aspects, the current position indication indicates at least one of a global navigation satellite system location of the HAPS, a location of the HAPS with respect to a local coordinate system, or a location of the HAPS with respect to an Earth-centered, Earth-fixed coordinate system.

In a tenth aspect, alone or in combination with one or more of the first through ninth aspects, the motion information indicates an altitude of the HAPS.

In an eleventh aspect, alone or in combination with one or more of the first through tenth aspects, the motion information comprises a target position indication that indicates a target position of the HAPS and a deviation indication that indicates a deviation of the HAPS from the target position.

In a twelfth aspect, alone or in combination with one or more of the first through eleventh aspects, the target position indication indicates at least one of a global navigation satellite system target location of the HAPS, a target location of the HAPS with respect to a local coordinate system, or a target location of the HAPS with respect to an Earth-centered, Earth-fixed coordinate system.

In a thirteenth aspect, alone or in combination with one or more of the first through twelfth aspects, receiving the motion information comprises receiving a first communication that includes the target position indication, and receiving a second communication that includes the deviation indication.

In a fourteenth aspect, alone or in combination with one or more of the first through thirteenth aspects, the first communication comprises a first SIB and the second communication comprises a second SIB that is different than the first SIB.

In a fifteenth aspect, alone or in combination with one or more of the first through fourteenth aspects, receiving the motion information comprises receiving at least one instance of a first communication that includes the target position indication, and receiving a plurality of instances of a second communication that includes the deviation indication.

In a sixteenth aspect, alone or in combination with one or more of the first through fifteenth aspects, receiving the at least one instance of the first communication comprises receiving a plurality of instances of the first communication based at least in part on a first repetition frequency, and receiving the plurality of instances of the second communication comprises receiving the plurality of instances of the second communication based at least in part on a second repetition frequency that is higher than the first repetition frequency.

In a seventeenth aspect, alone or in combination with one or more of the first through sixteenth aspects, the motion information is associated with a time instant.

In an eighteenth aspect, alone or in combination with one or more of the first through seventeenth aspects, the motion information includes a time instant indication that indicates the time instant.

In a nineteenth aspect, alone or in combination with one or more of the first through eighteenth aspects, the time instant indication indicates the time instant in accordance with a coordinated universal time.

In a twentieth aspect, alone or in combination with one or more of the first through nineteenth aspects, the time instant indication comprises an implicit indication.

In a twenty-first aspect, alone or in combination with one or more of the first through twentieth aspects, the time instant indication comprises a start of a downlink frame in which the motion information is transmitted.

In a twenty-second aspect, alone or in combination with one or more of the first through twenty-first aspects, the motion information comprises a velocity indication that indicates a velocity of the HAPS.

In a twenty-third aspect, alone or in combination with one or more of the first through twenty-second aspects, process 700 includes receiving motion information associated with at least one additional HAPS.

In a twenty-fourth aspect, alone or in combination with one or more of the first through twenty-third aspects, the motion information comprises at least one of a position indication that indicates a position of the at least one additional HAPS, a velocity indication that indicates a velocity of the at least one additional HAPS, or an identifier associated with the at least one additional HAPS.

In a twenty-fifth aspect, alone or in combination with one or more of the first through twenty-fourth aspects, the identifier comprises a cell identifier associated with the at least one additional HAPS.

In a twenty-sixth aspect, alone or in combination with one or more of the first through twenty-fifth aspects, the cell identifier comprises a physical cell identifier.

In a twenty-seventh aspect, alone or in combination with one or more of the first through twenty-sixth aspects, receiving the motion information associated with the at least one additional HAPS comprises receiving a system information block that includes the motion information associated with the at least one additional HAPS.

In a twenty-eighth aspect, alone or in combination with one or more of the first through twenty-seventh aspects, process 700 includes transmitting a motion information request to the network node, wherein receiving the motion information associated with at least one additional HAPS comprises receiving a response message corresponding to the request.

In a twenty-ninth aspect, alone or in combination with one or more of the first through twenty-eighth aspects, the response message comprises at least one of a radio resource control message or a medium access control control element.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with indicating motion information associated with a HAPS.

As shown in FIG. 8, in some aspects, process 800 may include receiving, from a network node, motion information associated with a HAPS, wherein the motion information comprises a trajectory indication that indicates trajectory information associated with the HAPS (block 810). For example, the UE (e.g., using communication manager 140 and/or reception component 1202, depicted in FIG. 12) may receive, from a network node, motion information associated with a HAPS, wherein the motion information comprises a trajectory indication that indicates trajectory information associated with the HAPS, as described above.

As further shown in FIG. 8, in some aspects, process 800 may include communicating with at least one of the network node or a different network node based at least in part on the motion information (block 820). For example, the UE (e.g., using communication manager 140, reception component 1202, and/or transmission component 1204, depicted in FIG. 12) may communicate with at least one of the network node or a different network node based at least in part on the motion information, as described above.

Process 800 may include additional aspects, such as any single aspect or any combination of aspects described below and/or in connection with one or more other processes described elsewhere herein.

In a first aspect, the trajectory indication indicates a sequence of position indications, wherein each position indication indicates a position of the HAPS at a corresponding time instant.

In a second aspect, alone or in combination with the first aspect, each position indication indicates at least one of a global navigation satellite system location of the HAPS, a location of the HAPS with respect to a local coordinate system, or a location of the HAPS with respect to an Earth-centered, Earth-fixed coordinate system.

In a third aspect, alone or in combination with one or more of the first and second aspects, each position indication comprises a time instant indication that indicates the corresponding time instant.

In a fourth aspect, alone or in combination with one or more of the first through third aspects, the time instant indication indicates the corresponding time instant in accordance with a coordinated universal time.

In a fifth aspect, alone or in combination with one or more of the first through fourth aspects, each position indication comprises an implicit indication that indicates the corresponding time instant.

In a sixth aspect, alone or in combination with one or more of the first through fifth aspects, the implicit indication comprises an indication of a downlink frame boundary.

In a seventh aspect, alone or in combination with one or more of the first through sixth aspects, process 800 includes transmitting, while operating in a radio resource control connected mode, a trajectory indication request, wherein receiving the motion information comprises receiving the motion information based at least in part on the trajectory indication request.

In an eighth aspect, alone or in combination with one or more of the first through seventh aspects, process 800 includes determining at least one trajectory associated with the HAPS based at least in part on the trajectory indication.

In a ninth aspect, alone or in combination with one or more of the first through eighth aspects, determining the at least one trajectory comprises performing an interpolation operation associated with the trajectory indication.

In a tenth aspect, alone or in combination with one or more of the first through ninth aspects, process 800 includes receiving a neighbor trajectory indication that indicates trajectory information associated with at least one additional HAPS.

In an eleventh aspect, alone or in combination with one or more of the first through tenth aspects, the neighbor trajectory indication indicates a sequence of neighbor position indications, wherein each neighbor position indication indicates a position of the at least one additional HAPS at a corresponding time instant.

In a twelfth aspect, alone or in combination with one or more of the first through eleventh aspects, each neighbor position indication indicates at least one of a global navigation satellite system location of the at least one additional HAPS, a location of the at least one additional HAPS with respect to a local coordinate system, or a location of the at least one additional HAPS with respect to an Earth-centered, Earth-fixed coordinate system.

In a thirteenth aspect, alone or in combination with one or more of the first through twelfth aspects, each position indication comprises a time instant indication that indicates the corresponding time instant.

In a fourteenth aspect, alone or in combination with one or more of the first through thirteenth aspects, the time instant indication indicates the corresponding time instant in accordance with a coordinated universal time.

In a fifteenth aspect, alone or in combination with one or more of the first through fourteenth aspects, each neighbor position indication comprises an implicit indication that indicates the corresponding time instant.

In a sixteenth aspect, alone or in combination with one or more of the first through fifteenth aspects, the implicit indication comprises an indication of a downlink frame boundary.

In a seventeenth aspect, alone or in combination with one or more of the first through sixteenth aspects, process 800 includes transmitting, while operating in a radio resource control connected mode, a neighbor trajectory indication request, wherein receiving the neighbor trajectory indication comprises receiving the neighbor trajectory indication based at least in part on the neighbor trajectory indication request.

In an eighteenth aspect, alone or in combination with one or more of the first through seventeenth aspects, process 800 includes determining at least one trajectory associated with the at least one additional HAPS based at least in part on the neighbor trajectory indication.

In a nineteenth aspect, alone or in combination with one or more of the first through eighteenth aspects, determining the at least one trajectory comprises performing an interpolation operation associated with the neighbor trajectory indication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 510) performs operations associated with indicating motion information associated with a HAPS.

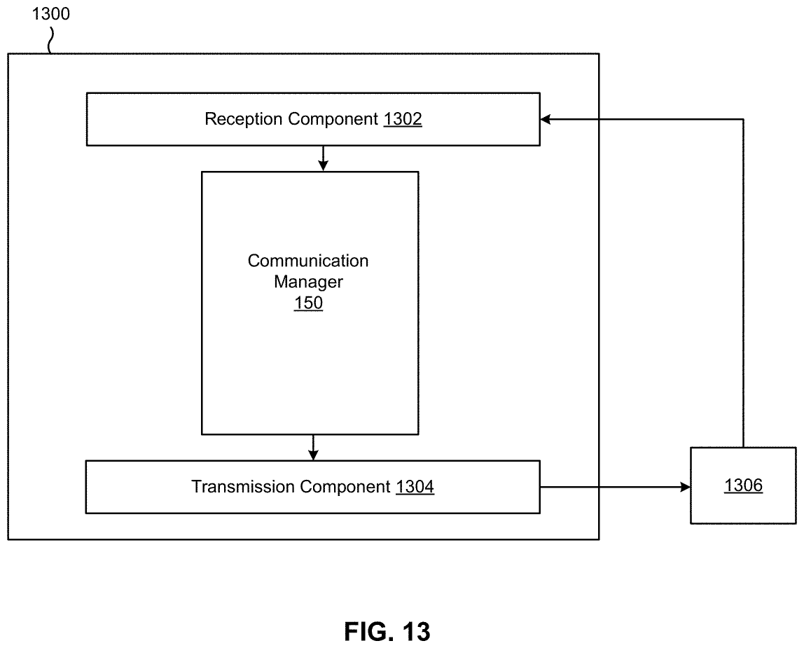

As shown in FIG. 9, in some aspects, process 900 may include transmitting motion information associated with a HAPS (block 910). For example, the network node (e.g., using communication manager 150 and/or transmission component 1304, depicted in FIG. 13) may transmit motion information associated with a HAPS, as described above.

As further shown in FIG. 9, in some aspects, process 900 may include communicating with at least one UE based at least in part on the motion information (block 920). For example, the network node (e.g., using communication manager 150, reception component 1302, and/or transmission component 1304, depicted in FIG. 13) may communicate with at least one UE based at least in part on the motion information, as described above.

Process 900 may include additional aspects, such as any single aspect or any combination of aspects described below and/or in connection with one or more other processes described elsewhere herein.

In a first aspect, the motion information comprises information associated with at least one of a position of the HAPS or a velocity of the HAPS.

In a second aspect, alone or in combination with the first aspect, transmitting the motion information comprises transmitting a broadcast transmission of a system information block that includes the motion information.

In a third aspect, alone or in combination with one or more of the first and second aspects, transmitting the motion information comprises transmitting a radio resource control message that includes the motion information.

In a fourth aspect, alone or in combination with one or more of the first through third aspects, transmitting the motion information comprises transmitting a medium access control control element that includes the motion information.

In a fifth aspect, alone or in combination with one or more of the first through fourth aspects, transmitting the motion information comprises transmitting a downlink control information transmission that includes the motion information.

In a sixth aspect, alone or in combination with one or more of the first through fifth aspects, the motion information indicates a delay pre-compensation to be applied by the UE to uplink transmissions to the HAPS.

In a seventh aspect, alone or in combination with one or more of the first through sixth aspects, the delay pre-compensation comprises at least one of a number of slots, a number of symbols, a period value, or a multiple of the period value.

In an eighth aspect, alone or in combination with one or more of the first through seventh aspects, the motion information indicates a position of the HAPS.

In a ninth aspect, alone or in combination with one or more of the first through eighth aspects, the motion information comprises a current position indication that indicates a current position of the HAPS.

In a tenth aspect, alone or in combination with one or more of the first through ninth aspects, the current position indication indicates at least one of a global navigation satellite system location of the HAPS, a location of the HAPS with respect to a local coordinate system, or a location of the HAPS with respect to an Earth-centered, Earth-fixed coordinate system.

In an eleventh aspect, alone or in combination with one or more of the first through tenth aspects, the motion information indicates an altitude of the HAPS.

In a twelfth aspect, alone or in combination with one or more of the first through eleventh aspects, the motion information comprises a target position indication that indicates a target position of the HAPS and a deviation indication that indicates a deviation of the HAPS from the target position.

In a thirteenth aspect, alone or in combination with one or more of the first through twelfth aspects, the target position indication indicates at least one of a global navigation satellite system target location of the HAPS, a target location of the HAPS with respect to a local coordinate system, or a target location of the HAPS with respect to an Earth-centered, Earth-fixed coordinate system.

In a fourteenth aspect, alone or in combination with one or more of the first through thirteenth aspects, transmitting the motion information comprises transmitting a first communication that includes the target position indication, and transmitting a second communication that includes the deviation indication.

In a fifteenth aspect, alone or in combination with one or more of the first through fourteenth aspects, the first communication comprises a first SIB and the second communication comprises a second SIB that is different than the first SIB.

In a sixteenth aspect, alone or in combination with one or more of the first through fifteenth aspects, transmitting the motion information comprises transmitting at least one instance of a first communication that includes the target position indication, and transmitting a plurality of instances of a second communication that includes the deviation indication.

In a seventeenth aspect, alone or in combination with one or more of the first through sixteenth aspects, transmitting the at least one instance of the first communication comprises transmitting a plurality of instances of the first communication based at least in part on a first repetition frequency, and transmitting the plurality of instances of the second communication comprises transmitting the plurality of instances of the second communication based at least in part on a second repetition frequency that is higher than the first repetition frequency.

In an eighteenth aspect, alone or in combination with one or more of the first through seventeenth aspects, the motion information is associated with a time instant.

In a nineteenth aspect, alone or in combination with one or more of the first through eighteenth aspects, the motion information includes a time instant indication that indicates the time instant.

In a twentieth aspect, alone or in combination with one or more of the first through nineteenth aspects, the time instant indication indicates the time instant in accordance with a coordinated universal time.

In a twenty-first aspect, alone or in combination with one or more of the first through twentieth aspects, the time instant indication comprises an implicit indication.

In a twenty-second aspect, alone or in combination with one or more of the first through twenty-first aspects, the time instant indication comprises a start of a downlink frame in which the motion information is transmitted.

In a twenty-third aspect, alone or in combination with one or more of the first through twenty-second aspects, the motion information comprises a velocity indication that indicates a velocity of the HAPS.

In a twenty-fourth aspect, alone or in combination with one or more of the first through twenty-third aspects, the motion information comprises a trajectory indication that indicates trajectory information associated with the HAPS.

In a twenty-fifth aspect, alone or in combination with one or more of the first through twenty-fourth aspects, the trajectory indication indicates a sequence of position indications, wherein each position indication indicates a position of the HAPS at a corresponding time instant.

In a twenty-sixth aspect, alone or in combination with one or more of the first through twenty-fifth aspects, each position indication indicates at least one of a global navigation satellite system location of the HAPS, a location of the HAPS with respect to a local coordinate system, or a location of the HAPS with respect to an Earth-centered, Earth-fixed coordinate system.

In a twenty-seventh aspect, alone or in combination with one or more of the first through twenty-sixth aspects, each position indication comprises a time instant indication that indicates the corresponding time instant.

In a twenty-eighth aspect, alone or in combination with one or more of the first through twenty-seventh aspects, the time instant indication indicates the corresponding time instant in accordance with a coordinated universal time.

In a twenty-ninth aspect, alone or in combination with one or more of the first through twenty-eighth aspects, each position indication comprises an implicit indication that indicates the corresponding time instant.

In a thirtieth aspect, alone or in combination with one or more of the first through twenty-ninth aspects, the implicit indication comprises an indication of a downlink frame boundary.

In a thirty-first aspect, alone or in combination with one or more of the first through thirtieth aspects, process 900 includes receiving, from the at least one UE while the at least one UE is operating in a radio resource control connected mode, a trajectory indication request, wherein transmitting the motion information comprises transmitting the motion information based at least in part on the trajectory indication request.

In a thirty-second aspect, alone or in combination with one or more of the first through thirty-first aspects, process 900 includes transmitting a neighbor trajectory indication that indicates trajectory information associated with at least one additional HAPS.

In a thirty-third aspect, alone or in combination with one or more of the first through thirty-second aspects, the neighbor trajectory indication indicates a sequence of neighbor position indications, wherein each neighbor position indication indicates a position of the at least one additional HAPS at a corresponding time instant.

In a thirty-fourth aspect, alone or in combination with one or more of the first through thirty-third aspects, each neighbor position indication indicates at least one of a global navigation satellite system location of the at least one additional HAPS, a location of the at least one additional HAPS with respect to a local coordinate system, or a location of the at least one additional HAPS with respect to an Earth-centered, Earth-fixed coordinate system.

In a thirty-fifth aspect, alone or in combination with one or more of the first through thirty-fourth aspects, each position indication comprises a time instant indication that indicates the corresponding time instant.

In a thirty-sixth aspect, alone or in combination with one or more of the first through thirty-fifth aspects, the time instant indication indicates the corresponding time instant in accordance with a coordinated universal time.

In a thirty-seventh aspect, alone or in combination with one or more of the first through thirty-sixth aspects, each neighbor position indication comprises an implicit indication that indicates the corresponding time instant.

In a thirty-eighth aspect, alone or in combination with one or more of the first through thirty-seventh aspects, the implicit indication comprises an indication of a downlink frame boundary.

In a thirty-ninth aspect, alone or in combination with one or more of the first through thirty-eighth aspects, process 900 includes receiving, from the at least one UE while the at least one UE is operating in a radio resource control connected mode, a neighbor trajectory indication request, wherein transmitting the neighbor trajectory indication comprises transmitting the neighbor trajectory indication based at least in part on the neighbor trajectory indication request.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 510) performs operations associated with indicating motion information associated with a HAPS.

As shown in FIG. 10, in some aspects, process 1000 may include transmitting motion information associated with a HAPS, wherein the motion information comprises information associated with at least one of a position of the HAPS or a velocity of the HAPS (block 1010). For example, the network node (e.g., using communication manager 150 and/or transmission component 1304, depicted in FIG. 13) may transmit motion information associated with a HAPS, wherein the motion information comprises information associated with at least one of a position of the HAPS or a velocity of the HAPS, as described above.

As further shown in FIG. 10, in some aspects, process 1000 may include communicating with at least one UE based at least in part on the motion information (block 1020). For example, the network node (e.g., using communication manager 150, reception component 1302, and/or transmission component 1304, depicted in FIG. 13) may communicate with at least one UE based at least in part on the motion information, as described above.

Process 1000 may include additional aspects, such as any single aspect or any combination of aspects described below and/or in connection with one or more other processes described elsewhere herein.

In a first aspect, transmitting the motion information comprises transmitting a broadcast transmission of a system information block that includes the motion information.

In a second aspect, alone or in combination with the first aspect, transmitting the motion information comprises transmitting a radio resource control message that includes the motion information.

In a third aspect, alone or in combination with one or more of the first and second aspects, transmitting the motion information comprises transmitting a medium access control control element that includes the motion information.

In a fourth aspect, alone or in combination with one or more of the first through third aspects, transmitting the motion information comprises transmitting a downlink control information transmission that includes the motion information.

In a fifth aspect, alone or in combination with one or more of the first through fourth aspects, the motion information indicates a delay pre-compensation to be applied by the UE to uplink transmissions to the HAPS.

In a sixth aspect, alone or in combination with one or more of the first through fifth aspects, the delay pre-compensation comprises at least one of a number of slots, a number of symbols, a period value, or a multiple of the period value.

In a seventh aspect, alone or in combination with one or more of the first through sixth aspects, the motion information indicates a position of the HAPS.

In an eighth aspect, alone or in combination with one or more of the first through seventh aspects, the motion information comprises a current position indication that indicates a current position of the HAPS.

In a ninth aspect, alone or in combination with one or more of the first through eighth aspects, the current position indication indicates at least one of a global navigation satellite system location of the HAPS, a location of the HAPS with respect to a local coordinate system, or a location of the HAPS with respect to an Earth-centered, Earth-fixed coordinate system.

In a tenth aspect, alone or in combination with one or more of the first through ninth aspects, the motion information indicates an altitude of the HAPS.

In an eleventh aspect, alone or in combination with one or more of the first through tenth aspects, the motion information comprises a target position indication that indicates a target position of the HAPS and a deviation indication that indicates a deviation of the HAPS from the target position.

In a twelfth aspect, alone or in combination with one or more of the first through eleventh aspects, the target position indication indicates at least one of a global navigation satellite system target location of the HAPS, a target location of the HAPS with respect to a local coordinate system, or a target location of the HAPS with respect to an Earth-centered, Earth-fixed coordinate system.

In a thirteenth aspect, alone or in combination with one or more of the first through twelfth aspects, transmitting the motion information comprises transmitting a first communication that includes the target position indication, and transmitting a second communication that includes the deviation indication.

In a fourteenth aspect, alone or in combination with one or more of the first through thirteenth aspects, the first communication comprises a first SIB and the second communication comprises a second SIB that is different than the first SIB.

In a fifteenth aspect, alone or in combination with one or more of the first through fourteenth aspects, transmitting the motion information comprises transmitting at least one instance of a first communication that includes the target position indication, and transmitting a plurality of instances of a second communication that includes the deviation indication.

In a sixteenth aspect, alone or in combination with one or more of the first through fifteenth aspects, transmitting the at least one instance of the first communication comprises transmitting a plurality of instances of the first communication based at least in part on a first repetition frequency, and transmitting the plurality of instances of the second communication comprises transmitting the plurality of instances of the second communication based at least in part on a second repetition frequency that is higher than the first repetition frequency.

In a seventeenth aspect, alone or in combination with one or more of the first through sixteenth aspects, the motion information is associated with a time instant.

In an eighteenth aspect, alone or in combination with one or more of the first through seventeenth aspects, the motion information includes a time instant indication that indicates the time instant.

In a nineteenth aspect, alone or in combination with one or more of the first through eighteenth aspects, the time instant indication indicates the time instant in accordance with a coordinated universal time.

In a twentieth aspect, alone or in combination with one or more of the first through nineteenth aspects, the time instant indication comprises an implicit indication.

In a twenty-first aspect, alone or in combination with one or more of the first through twentieth aspects, the time instant indication comprises a start of a downlink frame in which the motion information is transmitted.

In a twenty-second aspect, alone or in combination with one or more of the first through twenty-first aspects, the motion information comprises a velocity indication that indicates a velocity of the HAPS.

In a twenty-third aspect, alone or in combination with one or more of the first through twenty-second aspects, process 1000 includes transmitting motion information associated with at least one additional HAPS.

In a twenty-fourth aspect, alone or in combination with one or more of the first through twenty-third aspects, the motion information comprises at least one of a position indication that indicates a position of the at least one additional HAPS, a velocity indication that indicates a velocity of the at least one additional HAPS, or an identifier associated with the at least one additional HAPS.

In a twenty-fifth aspect, alone or in combination with one or more of the first through twenty-fourth aspects, the identifier comprises a cell identifier associated with the at least one additional HAPS.

In a twenty-sixth aspect, alone or in combination with one or more of the first through twenty-fifth aspects, the cell identifier comprises a physical cell identifier.

In a twenty-seventh aspect, alone or in combination with one or more of the first through twenty-sixth aspects, transmitting the motion information associated with the at least one additional HAPS comprises transmitting a system information block that includes the motion information associated with the at least one additional HAPS.

In a twenty-eighth aspect, alone or in combination with one or more of the first through twenty-seventh aspects, process 1000 includes receiving a motion information request from the at least one UE, wherein transmitting the motion information associated with at least one additional HAPS comprises transmitting a response message corresponding to the request.

In a twenty-ninth aspect, alone or in combination with one or more of the first through twenty-eighth aspects, the response message comprises at least one of a radio resource control message or a medium access control control element.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

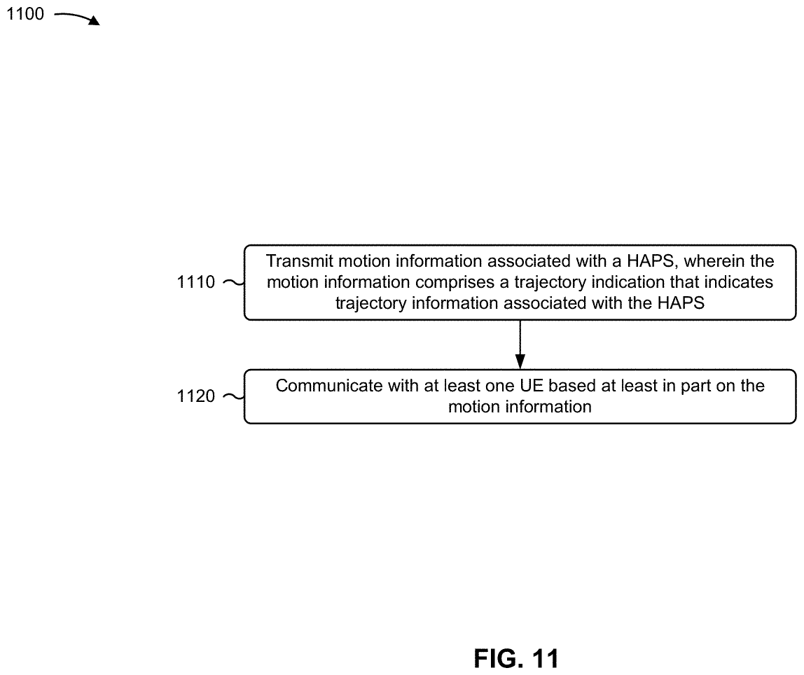

FIG. 11 is a diagram illustrating an example process 1100 performed, for example, by a network node, in accordance with the present disclosure. Example process 1100 is an example where the network node (e.g., network node 510) performs operations associated with indicating motion information associated with a HAPS.

As shown in FIG. 11, in some aspects, process 1100 may include transmitting motion information associated with a HAPS, wherein the motion information comprises a trajectory indication that indicates trajectory information associated with the HAPS (block 1110). For example, the network node (e.g., using communication manager 150 and/or transmission component 1304, depicted in FIG. 13) may transmit motion information associated with a HAPS, wherein the motion information comprises a trajectory indication that indicates trajectory information associated with the HAPS, as described above.

As further shown in FIG. 11, in some aspects, process 1100 may include communicating with at least one UE based at least in part on the motion information (block 1120). For example, the network node (e.g., using communication manager 150, reception component 1302, and/or transmission component 1304, depicted in FIG. 13) may communicate with at least one UE based at least in part on the motion information, as described above.

Process 1100 may include additional aspects, such as any single aspect or any combination of aspects described below and/or in connection with one or more other processes described elsewhere herein.

In a first aspect, the trajectory indication indicates a sequence of position indications, wherein each position indication indicates a position of the HAPS at a corresponding time instant.

In a second aspect, alone or in combination with the first aspect, each position indication indicates at least one of a global navigation satellite system location of the HAPS, a location of the HAPS with respect to a local coordinate system, or a location of the HAPS with respect to an Earth-centered, Earth-fixed coordinate system.

In a third aspect, alone or in combination with one or more of the first and second aspects, each position indication comprises a time instant indication that indicates the corresponding time instant.

In a fourth aspect, alone or in combination with one or more of the first through third aspects, the time instant indication indicates the corresponding time instant in accordance with a coordinated universal time.

In a fifth aspect, alone or in combination with one or more of the first through fourth aspects, each position indication comprises an implicit indication that indicates the corresponding time instant.

In a sixth aspect, alone or in combination with one or more of the first through fifth aspects, the implicit indication comprises an indication of a downlink frame boundary.

In a seventh aspect, alone or in combination with one or more of the first through sixth aspects, process 1100 includes receiving, from the at least one UE while the at least one UE is operating in a radio resource control connected mode, a trajectory indication request, wherein transmitting the motion information comprises transmitting the motion information based at least in part on the trajectory indication request.

In an eighth aspect, alone or in combination with one or more of the first through seventh aspects, process 1100 includes transmitting a neighbor trajectory indication that indicates trajectory information associated with at least one additional HAPS.

In a ninth aspect, alone or in combination with one or more of the first through eighth aspects, the neighbor trajectory indication indicates a sequence of neighbor position indications, wherein each neighbor position indication indicates a position of the at least one additional HAPS at a corresponding time instant.

In a tenth aspect, alone or in combination with one or more of the first through ninth aspects, each neighbor position indication indicates at least one of a global navigation satellite system location of the at least one additional HAPS, a location of the at least one additional HAPS with respect to a local coordinate system, or a location of the at least one additional HAPS with respect to an Earth-centered, Earth-fixed coordinate system.

In an eleventh aspect, alone or in combination with one or more of the first through tenth aspects, each position indication comprises a time instant indication that indicates the corresponding time instant.

In a twelfth aspect, alone or in combination with one or more of the first through eleventh aspects, the time instant indication indicates the corresponding time instant in accordance with a coordinated universal time.

In a thirteenth aspect, alone or in combination with one or more of the first through twelfth aspects, each neighbor position indication comprises an implicit indication that indicates the corresponding time instant.

In a fourteenth aspect, alone or in combination with one or more of the first through thirteenth aspects, the implicit indication comprises an indication of a downlink frame boundary.

In a fifteenth aspect, alone or in combination with one or more of the first through fourteenth aspects, process 1100 includes receiving, from the at least one UE while the at least one UE is operating in a radio resource control connected mode, a neighbor trajectory indication request, wherein transmitting the neighbor trajectory indication comprises transmitting the neighbor trajectory indication based at least in part on the neighbor trajectory indication request.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a determination component 1208.

In some aspects, the apparatus 1200 may be configured to perform one or more operations described herein in connection with FIG. 5. Additionally, or alternatively, the apparatus 1200 may be configured to perform one or more processes described herein, such as process 600 of FIG. 6, process 700 of FIG. 7, process 800 of FIG. 8, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for determining, means for obtaining, means for sending, means for outputting for transmission, means for determining, means for performing, means for transmitting, or means for receiving may include various processing system components, such as a receive processor, a transmit processor, a controller/processor, a memory, or a combination thereof, of the UE described above in connection with FIG. 2.

The reception component 1202 may receive, from a network node, motion information associated with a HAPS. The communication manager 140, the reception component 1202, and/or the transmission component 1204 may communicate with at least one of the network node or a different network node based at least in part on the motion information. In some aspects, the communication manager 140 may include one or more antennas, a modem, a modulator, a transmit MIMO processor, a transmit processor, a controller/processor, a memory, or a combination thereof, of the UE described in connection with FIG. 2. In some aspects, the communication manager 140 may include the reception component 1202 and/or the transmission component 1204.

The reception component 1202 may receive motion information associated with at least one additional HAPS.

The transmission component 1204 may transmit a motion information request to the network node, wherein receiving the motion information associated with at least one additional HAPS comprises receiving a response message corresponding to the request.

The transmission component 1204 may transmit, while operating in a radio resource control connected mode, a trajectory indication request, wherein receiving the motion information comprises receiving the motion information based at least in part on the trajectory indication request.

The determination component 1208 may determine at least one trajectory associated with the HAPS based at least in part on the trajectory indication. In some aspects, the determination component 1208 may include one or more antennas, a modem, a modulator, a transmit MIMO processor, a transmit processor, a controller/processor, a memory, or a combination thereof, of the UE described in connection with FIG. 2. In some aspects, the determination component 1208 may include the reception component 1202 and/or the transmission component 1204.

The reception component 1202 may receive a neighbor trajectory indication that indicates trajectory information associated with at least one additional HAPS.

The transmission component 1204 may transmit, while operating in a radio resource control connected mode, a neighbor trajectory indication request, wherein receiving the neighbor trajectory indication comprises receiving the neighbor trajectory indication based at least in part on the neighbor trajectory indication request.

The determination component 1208 may determine at least one trajectory associated with the at least one additional HAPS based at least in part on the neighbor trajectory indication.

The reception component 1202 may receive, from a network node, motion information associated with a HAPS, wherein the motion information comprises information associated with at least one of a position of the HAPS or a velocity of the HAPS.

The reception component 1202 may receive motion information associated with at least one additional HAPS.

The transmission component 1204 may transmit a motion information request to the network node, wherein receiving the motion information associated with at least one additional HAPS comprises receiving a response message corresponding to the request.

The reception component 1202 may receive, from a network node, motion information associated with a HAPS, wherein the motion information comprises a trajectory indication that indicates trajectory information associated with the HAPS.

The transmission component 1204 may transmit, while operating in a radio resource control connected mode, a trajectory indication request, wherein receiving the motion information comprises receiving the motion information based at least in part on the trajectory indication request.

The determination component 1208 may determine at least one trajectory associated with the HAPS based at least in part on the trajectory indication.

The reception component 1202 may receive a neighbor trajectory indication that indicates trajectory information associated with at least one additional HAPS.

The transmission component 1204 may transmit, while operating in a radio resource control connected mode, a neighbor trajectory indication request, wherein receiving the neighbor trajectory indication comprises receiving the neighbor trajectory indication based at least in part on the neighbor trajectory indication request.

The determination component 1208 may determine at least one trajectory associated with the at least one additional HAPS based at least in part on the neighbor trajectory indication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150.

In some aspects, the apparatus 1300 may be configured to perform one or more operations described herein in connection with FIG. 5. Additionally, or alternatively, the apparatus 1300 may be configured to perform one or more processes described herein, such as process 900 of FIG. 9, process 1000 of FIG. 10, process 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for determining, means for obtaining, means for sending, means for outputting for transmission, means for determining, means for performing, means for transmitting, or means for receiving may include various processing system components, such as a receive processor, a transmit processor, a controller/processor, a memory, or a combination thereof, of the network node described above in connection with FIG. 2.

The transmission component 1304 may transmit motion information associated with a HAPS. The communication manager 150, the reception component 1302, and/or the transmission component 1304 may communicate with at least one UE based at least in part on the motion information. In some aspects, the communication manager 150 may include one or more antennas, a modem, a modulator, a transmit MIMO processor, a transmit processor, a controller/processor, a memory, or a combination thereof, of the network node described in connection with FIG. 2. In some aspects, the communication manager 150 may include the reception component 1302 and/or the transmission component 1304.

The reception component 1302 may receive, from the at least one UE while the at least one UE is operating in a radio resource control connected mode, a trajectory indication request, wherein transmitting the motion information comprises transmitting the motion information based at least in part on the trajectory indication request.

The transmission component 1304 may transmit a neighbor trajectory indication that indicates trajectory information associated with at least one additional HAPS.

The reception component 1302 may receive, from the at least one UE while the at least one UE is operating in a radio resource control connected mode, a neighbor trajectory indication request, wherein transmitting the neighbor trajectory indication comprises transmitting the neighbor trajectory indication based at least in part on the neighbor trajectory indication request.

The transmission component 1304 may transmit motion information associated with a HAPS, wherein the motion information comprises information associated with at least one of a position of the HAPS or a velocity of the HAPS.

The transmission component 1304 may transmit motion information associated with at least one additional HAPS.

The reception component 1302 may receive a motion information request from the at least one UE, wherein transmitting the motion information associated with at least one additional HAPS comprises transmitting a response message corresponding to the request.

The transmission component 1304 may transmit motion information associated with a HAPS, wherein the motion information comprises a trajectory indication that indicates trajectory information associated with the HAPS.

The reception component 1302 may receive, from the at least one UE while the at least one UE is operating in a radio resource control connected mode, a trajectory indication request, wherein transmitting the motion information comprises transmitting the motion information based at least in part on the trajectory indication request.

The transmission component 1304 may transmit a neighbor trajectory indication that indicates trajectory information associated with at least one additional HAPS.

The reception component 1302 may receive, from the at least one UE while the at least one UE is operating in a radio resource control connected mode, a neighbor trajectory indication request, wherein transmitting the neighbor trajectory indication comprises transmitting the neighbor trajectory indication based at least in part on the neighbor trajectory indication request.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a network node, motion information associated with a high-altitude platform station (HAPS); and communicating with at least one of the network node or a different network node based at least in part on the motion information.

Aspect 2: The method of Aspect 1, wherein the motion information comprises information associated with at least one of a position of the HAPS or a velocity of the HAPS.

Aspect 3: The method of either of Aspects 1 or 2, wherein receiving the motion information comprises receiving a broadcast transmission of a system information block that includes the motion information.

Aspect 4: The method of any of Aspects 1-3, wherein receiving the motion information comprises receiving a radio resource control message that includes the motion information.

Aspect 5: The method of any of Aspects 1-4, wherein receiving the motion information comprises receiving a medium access control control element that includes the motion information.

Aspect 6: The method of any of Aspects 1-5, wherein receiving the motion information comprises receiving a downlink control information transmission that includes the motion information.

Aspect 7: The method of any of Aspects 1-6, wherein the motion information indicates a delay pre-compensation to be applied by the UE to uplink transmissions to the HAPS.

Aspect 8: The method of Aspect 7, wherein the delay pre-compensation comprises at least one of a number of slots, a number of symbols, a period value, or a multiple of the period value.

Aspect 9: The method of any of Aspects 1-8, wherein the motion information indicates a position of the HAPS.

Aspect 10: The method of any of Aspects 1-9, wherein the motion information comprises a current position indication that indicates a current position of the HAPS.

Aspect 11: The method of Aspect 10, wherein the current position indication indicates at least one of: a global navigation satellite system location of the HAPS, a location of the HAPS with respect to a local coordinate system, or a location of the HAPS with respect to an Earth-centered, Earth-fixed coordinate system.

Aspect 12: The method of any of Aspects 1-11, wherein the motion information indicates an altitude of the HAPS.

Aspect 13: The method of any of Aspects 1-12, wherein the motion information comprises a target position indication that indicates a target position of the HAPS and a deviation indication that indicates a deviation of the HAPS from the target position.

Aspect 14: The method of Aspect 13, wherein the target position indication indicates at least one of: a global navigation satellite system target location of the HAPS, a target location of the HAPS with respect to a local coordinate system, or a target location of the HAPS with respect to an Earth-centered, Earth-fixed coordinate system.

Aspect 15: The method of either of Aspects 13 or 14, wherein receiving the motion information comprises: receiving a first communication that includes the target position indication; and receiving a second communication that includes the deviation indication.

Aspect 16: The method of Aspect 15, wherein the first communication comprises a first system information block (SIB) and the second communication comprises a second SIB that is different than the first SIB.

Aspect 17: The method of any of Aspects 13-16, wherein receiving the motion information comprises: receiving at least one instance of a first communication that includes the target position indication; and receiving a plurality of instances of a second communication that include the deviation indication.

Aspect 18: The method of Aspect 17, wherein receiving the at least one instance of the first communication comprises receiving a plurality of instances of the first communication based at least in part on a first repetition frequency, and wherein receiving the plurality of instances of the second communication comprises receiving the plurality of instances of the second communication based at least in part on a second repetition frequency that is higher than the first repetition frequency.

Aspect 19: The method of any of Aspects 1-18, wherein the motion information is associated with a time instant.

Aspect 20: The method of Aspect 19, wherein the motion information includes a time instant indication that indicates the time instant.

Aspect 21: The method of Aspect 20, wherein the time instant indication indicates the time instant in accordance with a coordinated universal time.

Aspect 22: The method of either of Aspects 20 or 21, wherein the time instant indication comprises an implicit indication.

Aspect 23: The method of Aspect 22, wherein the time instant indication comprises a start of a downlink frame in which the motion information is transmitted.

Aspect 24: The method of any of Aspects 1-23, wherein the motion information comprises a velocity indication that indicates a velocity of the HAPS.

Aspect 25: The method of any of Aspects 1-24, further comprising receiving motion information associated with at least one additional HAPS.

Aspect 26: The method of Aspect 25, wherein the motion information associated with at least one additional HAPS comprises at least one of: a position indication that indicates a position of the at least one additional HAPS, a velocity indication that indicates a velocity of the at least one additional HAPS, or an identifier associated with the at least one additional HAPS.

Aspect 27: The method of Aspect 26, wherein the identifier comprises a cell identifier associated with the at least one additional HAPS.

Aspect 28: The method of Aspect 27, wherein the cell identifier comprises a physical cell identifier.

Aspect 29: The method of any of Aspects 25-28, wherein receiving the motion information associated with the at least one additional HAPS comprises receiving a system information block that includes the motion information associated with the at least one additional HAPS.

Aspect 30: The method of any of Aspects 25-29, further comprising transmitting a motion information request to the network node, wherein receiving the motion information associated with at least one additional HAPS comprises receiving a response message corresponding to the request.

Aspect 31: The method of Aspect 30, wherein the response message comprises at least one of a radio resource control message or a medium access control control element.

Aspect 32: The method of any of Aspects 1-31, wherein the motion information comprises a trajectory indication that indicates trajectory information associated with the HAPS.

Aspect 33: The method of Aspect 32, wherein the trajectory indication indicates a sequence of position indications, wherein each position indication indicates a position of the HAPS at a corresponding time instant.

Aspect 34: The method of Aspect 33, wherein each position indication indicates at least one of: a global navigation satellite system location of the HAPS, a location of the HAPS with respect to a local coordinate system, or a location of the HAPS with respect to an Earth-centered, Earth-fixed coordinate system.

Aspect 35: The method of either of Aspects 33 or 34, wherein each position indication comprises a time instant indication that indicates the corresponding time instant.

Aspect 36: The method of Aspect 35, wherein the time instant indication indicates the corresponding time instant in accordance with a coordinated universal time.

Aspect 37: The method of any of Aspects 33-36, wherein each position indication comprises an implicit indication that indicates the corresponding time instant.

Aspect 38: The method of Aspect 37, wherein the implicit indication comprises an indication of a downlink frame boundary.

Aspect 39: The method of any of Aspects 32-38, further comprising transmitting, while operating in a radio resource control connected mode, a trajectory indication request, wherein receiving the motion information comprises receiving the motion information based at least in part on the trajectory indication request.

Aspect 40: The method of any of Aspects 32-39, further comprising determining at least one trajectory associated with the HAPS based at least in part on the trajectory indication.

Aspect 41: The method of Aspect 40, wherein determining the at least one trajectory comprises performing an interpolation operation associated with the trajectory indication.

Aspect 42: The method of any of Aspects 1-41, further comprising receiving a neighbor trajectory indication that indicates trajectory information associated with at least one additional HAPS.

Aspect 43: The method of Aspect 42, wherein the neighbor trajectory indication indicates a sequence of neighbor position indications, wherein each neighbor position indication indicates a position of the at least one additional HAPS at a corresponding time instant.

Aspect 44: The method of Aspect 43, wherein each neighbor position indication indicates at least one of: a global navigation satellite system location of the at least one additional HAPS, a location of the at least one additional HAPS with respect to a local coordinate system, or a location of the at least one additional HAPS with respect to an Earth-centered, Earth-fixed coordinate system.

Aspect 45: The method of either of Aspects 43 or 44, wherein each position indication comprises a time instant indication that indicates the corresponding time instant.

Aspect 46: The method of Aspect 45, wherein the time instant indication indicates the corresponding time instant in accordance with a coordinated universal time.

Aspect 47: The method of any of Aspects 43-46, wherein each neighbor position indication comprises an implicit indication that indicates the corresponding time instant.

Aspect 48: The method of Aspect 47, wherein the implicit indication comprises an indication of a downlink frame boundary.

Aspect 49: The method of any of Aspects 42-48, further comprising transmitting, while operating in a radio resource control connected mode, a neighbor trajectory indication request, wherein receiving the neighbor trajectory indication comprises receiving the neighbor trajectory indication based at least in part on the neighbor trajectory indication request.

Aspect 50: The method of any of Aspects 42-49, further comprising determining at least one trajectory associated with the at least one additional HAPS based at least in part on the neighbor trajectory indication.

Aspect 51: The method of Aspect 50, wherein determining the at least one trajectory comprises performing an interpolation operation associated with the neighbor trajectory indication.

Aspect 52: A method of wireless communication performed by a user equipment (UE), comprising: receiving, from a network node, motion information associated with a high-altitude platform station (HAPS), wherein the motion information comprises information associated with at least one of a position of the HAPS or a velocity of the HAPS; and communicating with at least one of the network node or a different network node based at least in part on the motion information.

Aspect 53: The method of Aspect 52, wherein receiving the motion information comprises receiving a broadcast transmission of a system information block that includes the motion information.

Aspect 54: The method of either of Aspects 52 or 53, wherein receiving the motion information comprises receiving a radio resource control message that includes the motion information.

Aspect 55: The method of any of Aspects 52-54, wherein receiving the motion information comprises receiving a medium access control control element that includes the motion information.

Aspect 56: The method of any of Aspects 52-55, wherein receiving the motion information comprises receiving a downlink control information transmission that includes the motion information.

Aspect 57: The method of any of Aspects 52-56, wherein the motion information indicates a delay pre-compensation to be applied by the UE to uplink transmissions to the HAPS.

Aspect 58: The method of Aspect 57, wherein the delay pre-compensation comprises at least one of a number of slots, a number of symbols, a period value, or a multiple of the period value.

Aspect 59: The method of any of Aspects 52-58, wherein the motion information indicates a position of the HAPS.

Aspect 60: The method of any of Aspects 52-59, wherein the motion information comprises a current position indication that indicates a current position of the HAPS.

Aspect 61: The method of Aspect 60, wherein the current position indication indicates at least one of: a global navigation satellite system location of the HAPS, a location of the HAPS with respect to a local coordinate system, or a location of the HAPS with respect to an Earth-centered, Earth-fixed coordinate system.

Aspect 62: The method of any of Aspects 52-61, wherein the motion information indicates an altitude of the HAPS.

Aspect 63: The method of any of Aspects 52-62, wherein the motion information comprises a target position indication that indicates a target position of the HAPS and a deviation indication that indicates a deviation of the HAPS from the target position.

Aspect 64: The method of Aspect 63, wherein the target position indication indicates at least one of: a global navigation satellite system target location of the HAPS, a target location of the HAPS with respect to a local coordinate system, or a target location of the HAPS with respect to an Earth-centered, Earth-fixed coordinate system.

Aspect 65: The method of either of Aspects 63 or 64, wherein receiving the motion information comprises: receiving a first communication that includes the target position indication; and receiving a second communication that includes the deviation indication.

Aspect 66: The method of Aspect 65, wherein the first communication comprises a first system information block (SIB) and the second communication comprises a second SIB that is different than the first SIB.

Aspect 67: The method of any of Aspects 63-66, wherein receiving the motion information comprises: receiving at least one instance of a first communication that includes the target position indication; and receiving a plurality of instances of a second communication that includes the deviation indication.

Aspect 68: The method of Aspect 67, wherein receiving the at least one instance of the first communication comprises receiving a plurality of instances of the first communication based at least in part on a first repetition frequency, and wherein receiving the plurality of instances of the second communication comprises receiving the plurality of instances of the second communication based at least in part on a second repetition frequency that is higher than the first repetition frequency.

Aspect 69: The method of any of Aspects 52-68, wherein the motion information is associated with a time instant.

Aspect 70: The method of Aspect 69, wherein the motion information includes a time instant indication that indicates the time instant.

Aspect 71: The method of Aspect 70, wherein the time instant indication indicates the time instant in accordance with a coordinated universal time.

Aspect 72: The method of either of Aspects 70 or 71, wherein the time instant indication comprises an implicit indication.

Aspect 73: The method of Aspect 72, wherein the time instant indication comprises a start of a downlink frame in which the motion information is transmitted.

Aspect 74: The method of any of Aspects 52-73, wherein the motion information comprises a velocity indication that indicates a velocity of the HAPS.

Aspect 75: The method of any of Aspects 52-74, further comprising receiving motion information associated with at least one additional HAPS.

Aspect 76: The method of Aspect 75, wherein the motion information comprises at least one of: a position indication that indicates a position of the at least one additional HAPS, a velocity indication that indicates a velocity of the at least one additional HAPS, or an identifier associated with the at least one additional HAPS.

Aspect 77: The method of Aspect 76, wherein the identifier comprises a cell identifier associated with the at least one additional HAPS.

Aspect 78: The method of Aspect 77, wherein the cell identifier comprises a physical cell identifier.

Aspect 79: The method of any of Aspects 75-78, wherein receiving the motion information associated with the at least one additional HAPS comprises receiving a system information block that includes the motion information associated with the at least one additional HAPS.

Aspect 80: The method of any of Aspects 75-78, further comprising transmitting a motion information request to the network node, wherein receiving the motion information associated with at least one additional HAPS comprises receiving a response message corresponding to the request.

Aspect 81: The method of Aspect 80, wherein the response message comprises at least one of a radio resource control message or a medium access control control element.

Aspect 82: A method of wireless communication performed by a user equipment (UE), comprising: receiving, from a network node, motion information associated with a high-altitude platform station (HAPS), wherein the motion information comprises a trajectory indication that indicates trajectory information associated with the HAPS; and communicating with at least one of the network node or a different network node based at least in part on the motion information.

Aspect 83: The method of Aspect 82, wherein the trajectory indication indicates a sequence of position indications, wherein each position indication indicates a position of the HAPS at a corresponding time instant.

Aspect 84: The method of Aspect 83, wherein each position indication indicates at least one of: a global navigation satellite system location of the HAPS, a location of the HAPS with respect to a local coordinate system, or a location of the HAPS with respect to an Earth-centered, Earth-fixed coordinate system.

Aspect 85: The method of either of Aspects 83 or 84, wherein each position indication comprises a time instant indication that indicates the corresponding time instant.

Aspect 86: The method of Aspect 85, wherein the time instant indication indicates the corresponding time instant in accordance with a coordinated universal time.

Aspect 87: The method of any of Aspects 83-86, wherein each position indication comprises an implicit indication that indicates the corresponding time instant.

Aspect 88: The method of Aspect 87, wherein the implicit indication comprises an indication of a downlink frame boundary.

Aspect 89: The method of any of Aspects 82-88, further comprising transmitting, while operating in a radio resource control connected mode, a trajectory indication request, wherein receiving the motion information comprises receiving the motion information based at least in part on the trajectory indication request.

Aspect 90: The method of any of Aspects 82-89, further comprising determining at least one trajectory associated with the HAPS based at least in part on the trajectory indication.

Aspect 91: The method of Aspect 90, wherein determining the at least one trajectory comprises performing an interpolation operation associated with the trajectory indication.

Aspect 92: The method of any of Aspects 82-91, further comprising receiving a neighbor trajectory indication that indicates trajectory information associated with at least one additional HAPS.

Aspect 93: The method of Aspect 92, wherein the neighbor trajectory indication indicates a sequence of neighbor position indications, wherein each neighbor position indication indicates a position of the at least one additional HAPS at a corresponding time instant.

Aspect 94: The method of Aspect 93, wherein each neighbor position indication indicates at least one of: a global navigation satellite system location of the at least one additional HAPS, a location of the at least one additional HAPS with respect to a local coordinate system, or a location of the at least one additional HAPS with respect to an Earth-centered, Earth-fixed coordinate system.

Aspect 95: The method of either of Aspects 93 or 94, wherein each position indication comprises a time instant indication that indicates the corresponding time instant.

Aspect 96: The method of Aspect 95, wherein the time instant indication indicates the corresponding time instant in accordance with a coordinated universal time.

Aspect 97: The method of any of Aspects 93-96, wherein each neighbor position indication comprises an implicit indication that indicates the corresponding time instant.

Aspect 98: The method of Aspect 97, wherein the implicit indication comprises an indication of a downlink frame boundary.

Aspect 99: The method of any of Aspects 92-98, further comprising transmitting, while operating in a radio resource control connected mode, a neighbor trajectory indication request, wherein receiving the neighbor trajectory indication comprises receiving the neighbor trajectory indication based at least in part on the neighbor trajectory indication request.

Aspect 100: The method of any of Aspects 92-99, further comprising determining at least one trajectory associated with the at least one additional HAPS based at least in part on the neighbor trajectory indication.

Aspect 101: The method of Aspect 100, wherein determining the at least one trajectory comprises performing an interpolation operation associated with the neighbor trajectory indication.

Aspect 102: A method of wireless communication performed by a network node, comprising: transmitting motion information associated with a high-altitude platform station (HAPS); and communicating with at least one user equipment (UE) based at least in part on the motion information.

Aspect 103: The method of Aspect 102, wherein the motion information comprises information associated with at least one of a position of the HAPS or a velocity of the HAPS.

Aspect 104: The method of either of Aspects 102 or 103, wherein transmitting the motion information comprises transmitting a broadcast transmission of a system information block that includes the motion information.

Aspect 105: The method of any of Aspects 102-104, wherein transmitting the motion information comprises transmitting a radio resource control message that includes the motion information.

Aspect 106: The method of any of Aspects 102-105, wherein transmitting the motion information comprises transmitting a medium access control control element that includes the motion information.

Aspect 107: The method of any of Aspects 102-106, wherein transmitting the motion information comprises transmitting a downlink control information transmission that includes the motion information.

Aspect 108: The method of any of Aspects 102-107, wherein the motion information indicates a delay pre-compensation to be applied by the UE to uplink transmissions to the HAPS.

Aspect 109: The method of Aspect 108, wherein the delay pre-compensation comprises at least one of a number of slots, a number of symbols, a period value, or a multiple of the period value.

Aspect 110: The method of any of Aspects 102-109, wherein the motion information indicates a position of the HAPS.

Aspect 111: The method of any of Aspects 102-110, wherein the motion information comprises a current position indication that indicates a current position of the HAPS.

Aspect 112: The method of Aspect 111, wherein the current position indication indicates at least one of: a global navigation satellite system location of the HAPS, a location of the HAPS with respect to a local coordinate system, or a location of the HAPS with respect to an Earth-centered, Earth-fixed coordinate system.

Aspect 113: The method of any of Aspects 102-112, wherein the motion information indicates an altitude of the HAPS.

Aspect 114: The method of any of Aspects 102-113, wherein the motion information comprises a target position indication that indicates a target position of the HAPS and a deviation indication that indicates a deviation of the HAPS from the target position.

Aspect 115: The method of Aspect 114, wherein the target position indication indicates at least one of: a global navigation satellite system target location of the HAPS, a target location of the HAPS with respect to a local coordinate system, or a target location of the HAPS with respect to an Earth-centered, Earth-fixed coordinate system.

Aspect 116: The method of either of Aspects 114 or 115, wherein transmitting the motion information comprises: transmitting a first communication that includes the target position indication; and transmitting a second communication that includes the deviation indication.

Aspect 117: The method of Aspect 116, wherein the first communication comprises a first system information block (SIB) and the second communication comprises a second SIB that is different than the first SIB.

Aspect 118: The method of any of Aspects 114-117, wherein transmitting the motion information comprises: transmitting at least one instance of a first communication that includes the target position indication; and transmitting a plurality of instances of a second communication that includes the deviation indication.

Aspect 119: The method of Aspect 118, wherein transmitting the at least one instance of the first communication comprises transmitting a plurality of instances of the first communication based at least in part on a first repetition frequency, and wherein transmitting the plurality of instances of the second communication comprises transmitting the plurality of instances of the second communication based at least in part on a second repetition frequency that is higher than the first repetition frequency.

Aspect 120: The method of any of Aspects 102-119, wherein the motion information is associated with a time instant.

Aspect 121: The method of Aspect 120, wherein the motion information includes a time instant indication that indicates the time instant.

Aspect 122: The method of Aspect 121, wherein the time instant indication indicates the time instant in accordance with a coordinated universal time.

Aspect 123: The method of either of Aspects 121 or 122, wherein the time instant indication comprises an implicit indication.

Aspect 124: The method of Aspect 123, wherein the time instant indication comprises a start of a downlink frame in which the motion information is transmitted.

Aspect 125: The method of any of Aspects 102-124, wherein the motion information comprises a velocity indication that indicates a velocity of the HAPS.

Aspect 126: The method of any of Aspects 102-125, wherein the motion information comprises a trajectory indication that indicates trajectory information associated with the HAPS.

Aspect 127: The method of Aspect 126, wherein the trajectory indication indicates a sequence of position indications, wherein each position indication indicates a position of the HAPS at a corresponding time instant.

Aspect 128: The method of Aspect 127, wherein each position indication indicates at least one of: a global navigation satellite system location of the HAPS, a location of the HAPS with respect to a local coordinate system, or a location of the HAPS with respect to an Earth-centered, Earth-fixed coordinate system.

Aspect 129: The method of either of Aspects 127 or 128, wherein each position indication comprises a time instant indication that indicates the corresponding time instant.

Aspect 130: The method of Aspect 129, wherein the time instant indication indicates the corresponding time instant in accordance with a coordinated universal time.

Aspect 131: The method of any of Aspects 127-130, wherein each position indication comprises an implicit indication that indicates the corresponding time instant.

Aspect 132: The method of Aspect 131, wherein the implicit indication comprises an indication of a downlink frame boundary.

Aspect 133: The method of any of Aspects 102-132, further comprising receiving, from the at least one UE while the at least one UE is operating in a radio resource control connected mode, a trajectory indication request, wherein transmitting the motion information comprises transmitting the motion information based at least in part on the trajectory indication request.

Aspect 134: The method of any of Aspects 102-133, further comprising transmitting a neighbor trajectory indication that indicates trajectory information associated with at least one additional HAPS.

Aspect 135: The method of Aspect 134, wherein the neighbor trajectory indication indicates a sequence of neighbor position indications, wherein each neighbor position indication indicates a position of the at least one additional HAPS at a corresponding time instant.

Aspect 136: The method of Aspect 135, wherein each neighbor position indication indicates at least one of: a global navigation satellite system location of the at least one additional HAPS, a location of the at least one additional HAPS with respect to a local coordinate system, or a location of the at least one additional HAPS with respect to an Earth-centered, Earth-fixed coordinate system.

Aspect 137: The method of either of Aspects 135 or 136, wherein each position indication comprises a time instant indication that indicates the corresponding time instant.

Aspect 138: The method of Aspect 137, wherein the time instant indication indicates the corresponding time instant in accordance with a coordinated universal time.

Aspect 139: The method of any of Aspects 135-138, wherein each neighbor position indication comprises an implicit indication that indicates the corresponding time instant.

Aspect 140: The method of Aspect 139, wherein the implicit indication comprises an indication of a downlink frame boundary.

Aspect 141: The method of any of Aspects 134-140, further comprising receiving, from the at least one UE while the at least one UE is operating in a radio resource control connected mode, a neighbor trajectory indication request, wherein transmitting the neighbor trajectory indication comprises transmitting the neighbor trajectory indication based at least in part on the neighbor trajectory indication request.

Aspect 142: A method of wireless communication performed by a network node, comprising: transmitting motion information associated with a high-altitude platform station (HAPS), wherein the motion information comprises information associated with at least one of a position of the HAPS or a velocity of the HAPS; and communicating with at least one user equipment (UE) based at least in part on the motion information.

Aspect 143: The method of Aspect 142, wherein transmitting the motion information comprises transmitting a broadcast transmission of a system information block that includes the motion information.

Aspect 144: The method of either of Aspects 142 or 143, wherein transmitting the motion information comprises transmitting a radio resource control message that includes the motion information.

Aspect 145: The method of any of Aspects 142-144, wherein transmitting the motion information comprises transmitting a medium access control control element that includes the motion information.

Aspect 146: The method of any of Aspects 142-145, wherein transmitting the motion information comprises transmitting a downlink control information transmission that includes the motion information.

Aspect 147: The method of any of Aspects 142-146, wherein the motion information indicates a delay pre-compensation to be applied by the UE to uplink transmissions to the HAPS.

Aspect 148: The method of Aspect 147, wherein the delay pre-compensation comprises at least one of a number of slots, a number of symbols, a period value, or a multiple of the period value.

Aspect 149: The method of any of Aspects 142-148, wherein the motion information indicates a position of the HAPS.

Aspect 150: The method of any of Aspects 142-149, wherein the motion information comprises a current position indication that indicates a current position of the HAPS.

Aspect 151: The method of Aspect 150, wherein the current position indication indicates at least one of: a global navigation satellite system location of the HAPS, a location of the HAPS with respect to a local coordinate system, or a location of the HAPS with respect to an Earth-centered, Earth-fixed coordinate system.

Aspect 152: The method of any of Aspects 142-151, wherein the motion information indicates an altitude of the HAPS.

Aspect 153: The method of any of Aspects 142-152, wherein the motion information comprises a target position indication that indicates a target position of the HAPS and a deviation indication that indicates a deviation of the HAPS from the target position.

Aspect 154: The method of Aspect 153, wherein the target position indication indicates at least one of: a global navigation satellite system target location of the HAPS, a target location of the HAPS with respect to a local coordinate system, or a target location of the HAPS with respect to an Earth-centered, Earth-fixed coordinate system.

Aspect 155: The method of either of Aspects 153 or 154, wherein transmitting the motion information comprises: transmitting a first communication that includes the target position indication; and transmitting a second communication that includes the deviation indication.

Aspect 156: The method of Aspect 155, wherein the first communication comprises a first system information block (SIB) and the second communication comprises a second SIB that is different than the first SIB.

Aspect 157: The method of any of Aspects 153-156, wherein transmitting the motion information comprises: transmitting at least one instance of a first communication that includes the target position indication; and transmitting a plurality of instances of a second communication that includes the deviation indication.

Aspect 158: The method of Aspect 157, wherein transmitting the at least one instance of the first communication comprises transmitting a plurality of instances of the first communication based at least in part on a first repetition frequency, and wherein transmitting the plurality of instances of the second communication comprises transmitting the plurality of instances of the second communication based at least in part on a second repetition frequency that is higher than the first repetition frequency.

Aspect 159: The method of any of Aspects 142-158, wherein the motion information is associated with a time instant.

Aspect 160: The method of Aspect 159, wherein the motion information includes a time instant indication that indicates the time instant.

Aspect 161: The method of Aspect 160, wherein the time instant indication indicates the time instant in accordance with a coordinated universal time.

Aspect 162: The method of either of Aspects 160 or 161, wherein the time instant indication comprises an implicit indication.

Aspect 163: The method of Aspect 162, wherein the time instant indication comprises a start of a downlink frame in which the motion information is transmitted.

Aspect 164: The method of any of Aspects 142-163, wherein the motion information comprises a velocity indication that indicates a velocity of the HAPS.

Aspect 165: The method of any of Aspects 142-164, further comprising transmitting motion information associated with at least one additional HAPS.

Aspect 166: The method of Aspect 165, wherein the motion information comprises at least one of: a position indication that indicates a position of the at least one additional HAPS, a velocity indication that indicates a velocity of the at least one additional HAPS, or an identifier associated with the at least one additional HAPS.

Aspect 167: The method of Aspect 166, wherein the identifier comprises a cell identifier associated with the at least one additional HAPS.

Aspect 168: The method of Aspect 167, wherein the cell identifier comprises a physical cell identifier.

Aspect 169: The method of any of Aspects 165-168, wherein transmitting the motion information associated with the at least one additional HAPS comprises transmitting a system information block that includes the motion information associated with the at least one additional HAPS.

Aspect 170: The method of any of Aspects 165-169, further comprising receiving a motion information request from the at least one UE, wherein transmitting the motion information associated with at least one additional HAPS comprises transmitting a response message corresponding to the request.

Aspect 171: The method of Aspect 170, wherein the response message comprises at least one of a radio resource control message or a medium access control control element.

Aspect 172: A method of wireless communication performed by a network node, comprising: transmitting motion information associated with a high-altitude platform station (HAPS), wherein the motion information comprises a trajectory indication that indicates trajectory information associated with the HAPS; and communicating with at least one user equipment (UE) based at least in part on the motion information.

Aspect 173: The method of Aspect 172, wherein the trajectory indication indicates a sequence of position indications, wherein each position indication indicates a position of the HAPS at a corresponding time instant.

Aspect 174: The method of Aspect 173, wherein each position indication indicates at least one of: a global navigation satellite system location of the HAPS, a location of the HAPS with respect to a local coordinate system, or a location of the HAPS with respect to an Earth-centered, Earth-fixed coordinate system.

Aspect 175: The method of either of Aspects 173 or 174, wherein each position indication comprises a time instant indication that indicates the corresponding time instant.

Aspect 176: The method of Aspect 175, wherein the time instant indication indicates the corresponding time instant in accordance with a coordinated universal time.

Aspect 177: The method of any of Aspects 173-176, wherein each position indication comprises an implicit indication that indicates the corresponding time instant.

Aspect 178: The method of Aspect 177, wherein the implicit indication comprises an indication of a downlink frame boundary.

Aspect 179: The method of any of Aspects 173-178, further comprising receiving, from the at least one UE while the at least one UE is operating in a radio resource control connected mode, a trajectory indication request, wherein transmitting the motion information comprises transmitting the motion information based at least in part on the trajectory indication request.

Aspect 180: The method of any of Aspects 173-179, further comprising transmitting a neighbor trajectory indication that indicates trajectory information associated with at least one additional HAPS.

Aspect 181: The method of Aspect 180, wherein the neighbor trajectory indication indicates a sequence of neighbor position indications, wherein each neighbor position indication indicates a position of the at least one additional HAPS at a corresponding time instant.

Aspect 182: The method of Aspect 181, wherein each neighbor position indication indicates at least one of: a global navigation satellite system location of the at least one additional HAPS, a location of the at least one additional HAPS with respect to a local coordinate system, or a location of the at least one additional HAPS with respect to an Earth-centered, Earth-fixed coordinate system.

Aspect 183: The method of either of Aspects 181 or 182, wherein each position indication comprises a time instant indication that indicates the corresponding time instant.

Aspect 184: The method of Aspect 183, wherein the time instant indication indicates the corresponding time instant in accordance with a coordinated universal time.

Aspect 185: The method of any of Aspects 181-184, wherein each neighbor position indication comprises an implicit indication that indicates the corresponding time instant.

Aspect 186: The method of Aspect 185, wherein the implicit indication comprises an indication of a downlink frame boundary.

Aspect 187: The method of any of Aspects 180-186, further comprising receiving, from the at least one UE while the at least one UE is operating in a radio resource control connected mode, a neighbor trajectory indication request, wherein transmitting the neighbor trajectory indication comprises transmitting the neighbor trajectory indication based at least in part on the neighbor trajectory indication request.

Aspect 188: An apparatus for wireless communication, comprising one or more processors; memory coupled with the processor; and instructions stored in the memory and executable by the one or more processors to cause the apparatus to perform the method of one or more of Aspects 1-51.

Aspect 189: A user equipment (UE) for wireless communication, comprising a memory and one or more processors coupled to the memory, the one or more processors configured to cause the UE to perform the method of one or more of Aspects 1-51.

Aspect 190: An apparatus for wireless communication, comprising at least one means for performing the method of one or more of Aspects 1-51.

Aspect 191: A non-transitory computer-readable medium storing code for wireless communication, the code comprising instructions executable by one or more processors to perform the method of one or more of Aspects 1-51.

Aspect 192: An apparatus for wireless communication, comprising one or more processors; memory; and instructions stored in the memory and executable by the one or more processors to cause the apparatus to perform the method of one or more of Aspects 52-81.

Aspect 193: A user equipment (UE) for wireless communication, comprising a memory and one or more processors coupled to the memory, the one or more processors configured to cause the UE to perform the method of one or more of Aspects 52-81.

Aspect 194: An apparatus for wireless communication, comprising at least one means for performing the method of one or more of Aspects 52-81.

Aspect 195: A non-transitory computer-readable medium storing code for wireless communication, the code comprising instructions executable by a processor to perform the method of one or more of Aspects 52-81.

Aspect 196: An apparatus for wireless communication, comprising one or more processors; memory; and instructions stored in the memory and executable by the one or more processors to cause the apparatus to perform the method of one or more of Aspects 82-101.

Aspect 197: A user equipment (UE) for wireless communication, comprising a memory and one or more processors coupled to the memory, the one or more processors configured to cause the UE to perform the method of one or more of Aspects 82-101.

Aspect 198: An apparatus for wireless communication, comprising at least one means for performing the method of one or more of Aspects 82-101.

Aspect 199: A non-transitory computer-readable medium storing code for wireless communication, the code comprising instructions executable by a processor to perform the method of one or more of Aspects 82-101.

Aspect 200: An apparatus for wireless communication, comprising one or more processors; memory; and instructions stored in the memory and executable by the one or more processors to cause the apparatus to perform the method of one or more of Aspects 102-141.

Aspect 201: A high-altitude platform station (HAPS), comprising a memory and one or more processors coupled to the memory, the one or more processors configured to cause the HAPS to perform the method of one or more of Aspects 102-141.

Aspect 202: An apparatus for wireless communication, comprising at least one means for performing the method of one or more of Aspects 102-141.

Aspect 203: A non-transitory computer-readable medium storing code for wireless communication, the code comprising instructions executable by a processor to perform the method of one or more of Aspects 102-141.

Aspect 204: An apparatus for wireless communication, comprising one or more processors; memory; and instructions stored in the memory and executable by the one or more processors to cause the apparatus to perform the method of one or more of Aspects 142-171.

Aspect 205: A high-altitude platform station (HAPS) for wireless communication, comprising a memory and one or more processors coupled to the memory, the one or more processors configured to cause the HAPS to perform the method of one or more of Aspects 142-171.

Aspect 206: An apparatus for wireless communication, comprising at least one means for performing the method of one or more of Aspects 142-171.

Aspect 207: A non-transitory computer-readable medium storing code for wireless communication, the code comprising instructions executable by a processor to perform the method of one or more of Aspects 142-171.

Aspect 208: An apparatus for wireless communication, comprising one or more processors; memory; and instructions stored in the memory and executable by the one or more processors to cause the apparatus to perform the method of one or more of Aspects 172-187.

Aspect 209: A high-altitude platform station (HAPS) for wireless communication, comprising a memory and one or more processors coupled to the memory, the one or more processors configured to cause the HAPS to perform the method of one or more of Aspects 172-187.

Aspect 210: An apparatus for wireless communication, comprising at least one means for performing the method of one or more of Aspects 172-187.

Aspect 211: A non-transitory computer-readable medium storing code for wireless communication, the code comprising instructions executable by a processor to perform the method of one or more of Aspects 172-187.

Aspect 212: A method for wireless communication at an apparatus, comprising: obtaining, from a high-altitude platform station (HAPS), motion information associated with the HAPS; and communicating with the HAPS based at least in part on the motion information.

Aspect 213: The method of Aspect 212, wherein the motion information comprises information associated with at least one of a position of the HAPS, an altitude of the HAPS, or a velocity of the HAPS.

Aspect 214: The method of either of Aspects 212 or 213, wherein the motion information is obtained via at least one of a broadcast transmission of a system information block, a radio resource control message, a medium access control control element, or a downlink control information transmission.

Aspect 215: The method of any of Aspects 212-214, wherein the motion information indicates a delay pre-compensation to be applied by the apparatus to transmissions to the HAPS, wherein the delay pre-compensation comprises at least one of a number of slots, a number of symbols, a period value, or a multiple of the period value.

Aspect 216: The method of any of Aspects 212-215, wherein the motion information comprises at least one of a target position indication that indicates a target position of the HAPS or a deviation indication that indicates a deviation of the HAPS from the target position.

Aspect 217: The method of Aspect 216, wherein the motion information is obtained via at least one of: a first communication that includes the target position indication; or a second communication that includes the deviation indication.

Aspect 218: The method of Aspect 217, wherein the first communication comprises a first system information block (SIB) and the second communication comprises a second SIB that is different from the first SIB.

Aspect 219: The method of any of Aspects 216-218, wherein the motion information is obtained via at least one of: at least one instance of a first communication that includes the target position indication; or a plurality of instances of a second communication that include the deviation indication.

Aspect 220: The method of Aspect 219, wherein the at least one instance of the first communication is obtained based at least in part on a first repetition frequency, and wherein the plurality of instances of the second communication are obtained based at least in part on a second repetition frequency that is higher than the first repetition frequency.

Aspect 221: The method of any of Aspects 212-220, wherein the motion information comprises a trajectory indication that indicates at least one of trajectory information associated with the HAPS or a sequence of position indications, wherein each position indication indicates a position of the HAPS at a corresponding time instant.

Aspect 222: The method of Aspect 221, wherein each position indication comprises a time instant indication that indicates the respective corresponding time instant.

Aspect 223: The method of Aspect 222, wherein the time instant indication indicates the respective corresponding time instant in accordance with a coordinated universal time.

Aspect 224: The method of either of Aspects 222 or 223, wherein each position indication comprises an implicit indication that indicates the respective corresponding time instant.

Aspect 225: The method of Aspect 224, wherein the implicit indication comprises an indication of a downlink frame boundary.

Aspect 226: The method of any of Aspects 221-225, wherein the method further comprises outputting for transmission, while operating in a radio resource control connected mode, a trajectory indication request, and wherein the motion information is obtained based at least in part on the trajectory indication request.

Aspect 227: The method of any of Aspects 221-226, wherein the method further comprises communicating with the HAPS based at least in part on at least one trajectory, the at least one trajectory being based on the trajectory indication.

Aspect 228: The method of Aspect 227, wherein the method further comprises performing an interpolation operation associated with the trajectory indication, wherein the at least one trajectory is further based on the interpolation operation.

Aspect 229: A method for wireless communication at an apparatus, comprising: outputting for transmission motion information associated with the apparatus; and communicating with at least one user equipment (UE) based at least in part on the motion information.

Aspect 230: The method of Aspect 229, wherein the motion information comprises information associated with at least one of a position of the apparatus, an altitude of the HAPS, or a velocity of the apparatus.

Aspect 231: The method of either of Aspects 229 or 230, wherein the motion information is output for transmission via at least one of a broadcast transmission of a system information block, a radio resource control message, a radio resource control message, a medium access control control element, or a downlink control information transmission.

Aspect 232: The method of any of Aspects 229-231, wherein the motion information indicates a delay pre-compensation to be applied by the UE to transmissions to the apparatus, wherein the delay pre-compensation comprises at least one of a number of slots, a number of symbols, a period value, or a multiple of the period value.

Aspect 233: The method of any of Aspects 229-232, wherein the motion information comprises at least one of a target position indication that indicates a target position of the apparatus or a deviation indication that indicates a deviation of the apparatus from the target position.

Aspect 234: The method of any of Aspects 229-233, wherein the motion information is associated with a time instant.

Aspect 235: The method of any of Aspects 229-234, wherein the motion information comprises a trajectory indication that indicates trajectory information associated with the HAPS.

Aspect 236: The method of any of Aspects 229-235, wherein the method further comprises obtaining, from the at least one UE while the at least one UE is operating in a radio resource control connected mode, a trajectory indication request, wherein the motion information is output for transmission based at least in part on the trajectory indication request.

Aspect 237: An apparatus for wireless communication, comprising a memory comprising instructions; and one or more processors configured to execute the instructions and cause the apparatus to perform the method of one or more of Aspects 212-228.

Aspect 238: A device for wireless communication, comprising a memory and one or more processors coupled to the memory, the one or more processors configured to perform the method of one or more of Aspects 212-228.

Aspect 239: An apparatus for wireless communication, comprising at least one means for performing the method of one or more of Aspects 212-228.

Aspect 240: A non-transitory computer-readable medium storing a set of instructions for wireless communication, the set of instructions comprising one or more instructions that, when executed by one or more processors of a device, cause the device to perform the method of one or more of Aspects 212-228.

Aspect 241: An apparatus for wireless communication, comprising a memory comprising instructions; and one or more processors configured to execute the instructions and cause the apparatus to perform the method of one or more of Aspects 229-236.

Aspect 242: A device for wireless communication, comprising a memory and one or more processors coupled to the memory, the one or more processors configured to perform the method of one or more of Aspects 229-236.

Aspect 243: An apparatus for wireless communication, comprising at least one means for performing the method of one or more of Aspects 229-236.

Aspect 244: A non-transitory computer-readable medium storing a set of instructions for wireless communication, the set of instructions comprising one or more instructions that, when executed by one or more processors of a device, cause the device to perform the method of one or more of Aspects 229-236.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication, comprising:
a memory comprising instructions; and
one or more processors configured to execute the instructions and cause the apparatus to:
obtain, from a high-altitude platform station (HAPS), motion information associated with the HAPS; and
communicate with the HAPS based at least in part on the motion information.

2. The apparatus of claim 1, wherein the motion information comprises information associated with at least one of a position of the HAPS, an altitude of the HAPS, or a velocity of the HAPS.

3. The apparatus of claim 1, wherein the motion information is obtained via at least one of a broadcast transmission of a system information block, a radio resource control message, a medium access control control element, or a downlink control information transmission.

4. The apparatus of claim 1, wherein the motion information indicates a delay pre-compensation to be applied by the apparatus to transmissions to the HAPS, wherein the delay pre-compensation comprises at least one of a number of slots, a number of symbols, a period value, or a multiple of the period value.

5. The apparatus of claim 1, wherein the motion information comprises at least one of a target position indication that indicates a target position of the HAPS or a deviation indication that indicates a deviation of the HAPS from the target position.

6. The apparatus of claim 5, wherein the motion information is obtained via at least one of:
a first communication that includes the target position indication; or
a second communication that includes the deviation indication.

7. The apparatus of claim 6, wherein the first communication comprises a first system information block (SIB) and the second communication comprises a second SIB that is different from the first SIB.

8. The apparatus of claim 5, wherein the motion information is obtained via at least one of:
at least one instance of a first communication that includes the target position indication; or
a plurality of instances of a second communication that include the deviation indication.

9. The apparatus of claim 8, wherein the at least one instance of the first communication is obtained based at least in part on a first repetition frequency, and wherein the plurality of instances of the second communication are obtained based at least in part on a second repetition frequency that is higher than the first repetition frequency.

10. The apparatus of claim 1, wherein the motion information comprises a trajectory indication that indicates at least one of trajectory information associated with the HAPS or a sequence of position indications, wherein each position indication indicates a position of the HAPS at a corresponding time instant.

11. The apparatus of claim 10, wherein each position indication comprises a time instant indication that indicates the respective corresponding time instant.

12. The apparatus of claim 11, wherein the time instant indication indicates the respective corresponding time instant in accordance with a coordinated universal time.

13. The apparatus of claim 10, wherein each position indication comprises an implicit indication that indicates the respective corresponding time instant.

14. The apparatus of claim 13, wherein the implicit indication comprises an indication of a downlink frame boundary.

15. The apparatus of claim 10, wherein the one or more processors are further configured to cause the apparatus to output for transmission, while operating in a radio resource control connected mode, a trajectory indication request, and wherein the motion information is obtained based at least in part on the trajectory indication request.

16. The apparatus of claim 10, wherein the one or more processors are further configured to cause the apparatus to communicate with the HAPS based at least in part on at least one trajectory, the at least one trajectory being based on the trajectory indication.

17. The apparatus of claim 16, wherein the one or more processors are further configured to cause the apparatus to perform an interpolation operation associated with the trajectory indication, wherein the at least one trajectory is based on the interpolation operation.

18. The apparatus of claim 1, further comprising at least one transceiver configured to receive the motion information and communicate with the HAPS based at least in part on the motion information, wherein the apparatus is configured as a user equipment.

19. An apparatus for wireless communication, comprising:
a memory comprising instructions; and
one or more processors configured to execute the instructions and cause the apparatus to:
output for transmission motion information associated with the apparatus; and
communicate with at least one user equipment (UE) based at least in part on the motion information.

20. The apparatus of claim 19, wherein the motion information comprises information associated with at least one of a position of the apparatus, an altitude of the HAPS, or a velocity of the apparatus.

21. The apparatus of claim 19, wherein the motion information is output for transmission via at least one of a broadcast transmission of a system information block, a radio resource control message, a radio resource control message, a medium access control control element, or a downlink control information transmission.

22. The apparatus of claim 19, wherein the motion information indicates a delay pre-compensation to be applied by the UE to transmissions to the apparatus, wherein the delay pre-compensation comprises at least one of a number of slots, a number of symbols, a period value, or a multiple of the period value.

23. The apparatus of claim 19, wherein the motion information comprises at least one of a target position indication that indicates a target position of the apparatus or a deviation indication that indicates a deviation of the apparatus from the target position.

24. The apparatus of claim 19, wherein the motion information is associated with a time instant.

25. The apparatus of claim 19, wherein the motion information comprises a trajectory indication that indicates trajectory information associated with the HAPS.

26. The apparatus of claim 19, wherein the one or more processors are further configured to obtain, from the at least one UE while the at least one UE is operating in a radio resource control connected mode, a trajectory indication request, wherein the motion information is output for transmission based at least in part on the trajectory indication request.

27. The apparatus of claim 19, further comprising at least one transceiver configured to transmit the motion information and communicate with the at least one UE based at least in part on the motion information, wherein the apparatus is configured as a high-altitude platform station.
